(19) United States
(12) Patent Application Publication
(10) Pub. No.: US 2013/0022285 A1
(43) Pub. Date: Jan. 24, 2013

(54) IMAGE PROCESSING DEVICE AND METHOD

(71) Applicants: Teruhiko Suzuki, Kanagawa (JP); Peng Wang, Shanghai (CN)

(72) Inventors: Teruhiko Suzuki, Kanagawa (JP); Peng Wang, Shanghai (CN)

(73) Assignee: SONY CORPORATION, Tokyo (JP)

(21) Appl. No.: 13/575,326

(22) PCT Filed: Jan. 27, 2011
(86) PCT No.: PCT/JP2011/051543

§ 371 Date: Oct. 12, 2012

(30) Foreign Application Priority Data
Feb. 5, 2010 (JP) 2010-024895

(51) Int. Cl. G06K 9/36

(52) U.S. Cl. 382/233; 382/238

(57) ABSTRACT

The invention relates to image processing device and method that can further improve coding efficiency.

An orthogonal transform part 151 orthogonally transforms pixel values of a process target block of an input image by 4×4. A 2×2 block generation part 152 extracts four direct-current components from the coefficient data, and generates a 2×2 block using the direct-current components. An orthogonal transform part 153 further orthogonally transforms the 2×2 block. An 8×8 block generation part 161 generates an 8×8 block with the 2×2 block at the upper left portion. An inverse orthogonal transform part 162 subjects the supplied 8×8 curved surface block to inverse orthogonal transform. The pixel values of the 8×8 block subjected to inverse orthogonal transform form a curved surface. The curved surface constitutes a predicted image. The invention can be applied to an image processing device, for example.

### TECHNICAL FIELD

The invention relates to an image processing device and method, and more specifically, an image processing device and method that can further improve coding efficiency.

### BACKGROUND ART

In recent years, there have been becoming popular in both information distribution from broadcast stations and information reception at ordinary households, devices that conform to schemes such as Moving Picture Experts Group (MPEG) so as to handle image information digitally and, for the purpose of high-efficiency information transfer and accumulation, compress the digital image information through orthogonal transform such as discrete cosine transform and motion compensation using redundancy specific to image information.

In particular, MPEG2 (International Organization for Standardization (ISO)/International Electrotechnical Commission (IEC) 13818-2) is defined as a general-purpose image coding scheme, and is currently used in a wide variety of applications for professional users and consumers, covering all of interlace scanned images and sequentially scanned images, and standard-resolution images and high-resolution images. Using the MPEG2 compression technology, high compression rates and favorable image quality can be realized by assigning a coding amount (bit rate) of 4 to 8 Mbps for standard-resolution interlace scanned images with 720×480 pixels and assigning a coding amount of 18 to 22 Mbps to high-resolution interlace scanned images with 1920×1088 pixels, for example.

The MPEG2 was mainly targeted for high-resolution coding adapted for broadcasting, and did not cover lower coding amounts (bit rates) than those covered by the MPEG1, that is, did not support coding schemes with higher compression rates. It was presumed that there would be increasing needs for such coding schemes in the future due to popularization of cellular phones, and the MPEG4 coding scheme was standardized in correspondence with the presumption. Standard for image coding schemes was approved as international standards, ISO/IEC14496-2, in December, 1998.

Further, initially for the purpose of image coding for TV conferences, H.26L (ITU Telecommunication Standardization Sector (ITU-T) Q6/16 Video Coding Experts Group (VCEG)) has been being standardized in recent years. The H.26L scheme is known for realization of higher coding efficiency, even though it requires more computation amounts for coding and decoding as compared with the conventional coding schemes such as the MPEG 2 and the MPEG 4. In addition, as a part of activities for the MPEG 4, a coding scheme is currently under standardization, as Joint Model of Enhanced-Compression Video Coding for realization of higher coding efficiency, based on the H.26L and introducing capabilities not supported by the H.26L. In March, 2003, the foregoing schemes were internationally standardized under the names of H.264 and MPEG 4 Para 0 (Advanced Video Coding (AVC)).

Moreover, as an extension of the foregoing schemes, Fidelity Range Extension (FRExt) including coding tools for business use such as RGB, 4:2:2, and 4:4:4, 8×8 Discrete Cosine Transform (DCT) defined by the MPEG2, and a quantized matrix, was standardized. Accordingly, the coding scheme allowing even favorable expression of film noise in movies with the use of the H.264/AVC, was produced and used in various applications such as Blu-Ray Disc (trademark).

However, there have recently been increasing needs for further high-compression coding to compress images of about 4000×2000 pixels, which is four times that of high-vision images, and to distribute high-vision images in environments with limited transfer capacities, such as the Internet. To meet these needs, examinations for improvement of coding efficiency are continuously conducted on the VCEG under the ITU-T described above.

One of the factors for realization of higher coding efficiency by the H.264/AVC scheme, as compared with the conventional MPEG 2 scheme and the like, is an intra prediction process.

In the H.264/AVC scheme, intra prediction modes for brightness signals include nine kinds of prediction modes with blocks of 4×4 pixels and 8×8 pixels, and four kinds of prediction modes with macro blocks of 16×16 pixels. In addition, intra prediction modes for color-difference signals include four kinds of prediction modes with blocks of 8×8 pixels. The intra prediction modes for color-difference signals can be set independently from the intra prediction modes for brightness signals.

With regard to the intra prediction modes for brightness signals with 4×4 pixels and 8×8 pixels, one intra prediction mode is defined for each block of brightness signals with 4×4 pixels and 8×8 pixels. For the intra prediction mode for brightness signals with 16×16 pixels and the intra prediction modes for color-difference signals, one prediction mode is defined for one macro block.

In recent years, there have been suggested methods for further improving efficiency of intra prediction in the H.264/AVC scheme (see Non-patent Document 1 and Non-patent Document 2, for example).

### CITATION LIST

### Non-Patent Document

Non-patent Document 1: “Intra Prediction by Template Matching,” T. K. Tan et al, ICIP2006
Non-patent Document 2: “Tools for Improving Texture and Motion Compensation,” MPEG Workshop, October 2008

### SUMMARY OF THE INVENTION

### Problems to be Solved by the Invention

However, the compression rates provided by the H.264/AVC scheme are still insufficient, and there is need for further reduction of information in compression.

In view of the foregoing circumstances, an object of the invention is to further improve coding efficiency.

### Solutions to Problems

An aspect of the invention is an image processing device including: a curved surface parameter generation means that generates a curved surface parameter indicative of a curved surface approximating a pixel value of a process target block of image data to be subjected to in-screen coding, using the pixel value of the process target block; a curved surface generation means that generates the curved surface, as a predicted image, represented by the curved surface parameter generated by the curved surface parameter generation means; an arithmetic means that subtracts the pixel value of the curved surface generated as the predicted image by the curved surface generation means from the pixel value of the process target block, thereby to generate differential data; and a coding means that encodes the differential data generated by the arithmetic means.

The curved surface parameter generation means can generate the curved surface parameter by orthogonally transforming a direct-current component block formed by a direct-current component of coefficient data of the orthogonally transformed process target block. The curved surface generation means can generate the curved surface by subjecting the curved surface block having as a component the curved surface parameter generated by the curved surface parameter generation means, to inverse orthogonal transform.

The curved surface generation means can form a curved surface block with the same size as an in-screen prediction block size for use in in-screen prediction, thereby to subject the curved surface block of the same block size as the in-screen prediction block size to inverse orthogonal transform.

The curved surface size block can have a curved surface parameter and 0 as components.

The in-screen prediction block size can be 8×8, and the direct-current component block size can be 2×2.

The image processing device further includes an orthogonal-transform means that subjects the differential data generated by the arithmetic means to orthogonal transform; and a quantization means that quantizes coefficient data generated through orthogonal transforming of the differential data by the orthogonal-transform means. The coding means encodes the coefficient data quantized by the quantization means, thereby to generate coded data.

The image processing device further includes a transfer means that transforms the coded data generated by the coding means and the curved surface parameter generated by the curved surface parameter generation means.

The curved surface generation means includes: an 8×8 block generation means that generates an 8×8 block using the curved surface parameter generated by the curved surface parameter generation means; and an inverse orthogonal transform means that subjects the 8×8 block generated by the 8×8 block generation means to inverse orthogonal transform.

The coding means encodes the curved surface parameter generated by the curved surface parameter generation means, and the transfer means transfers the curved surface parameter coded by the encoding means.

Another aspect of the invention is an image processing method used by an image processing device, including: a curved surface parameter generation means of the image processing device generates a curved surface parameter indicative of a curved surface approximating a pixel value of a process target block of image data to be subjected to in-screen coding, using the pixel value of the process target block of the coded image data; a curved surface generation means of the image processing device generates the curved surface, as a predicted image, represented by the curved surface parameter generated; an arithmetic means of the image processing device subtracts the pixel value of the curved surface generated as the predicted image from the pixel value of the process target block, thereby to generate differential data; and a coding means of the image processing device encodes the differential data generated.

Another aspect of the invention is an image processing device, including: a decoding means that decodes coded data formed by coding differential data between image data and a predicted image subjected to intra prediction using the image data; a curved surface generation means that generates the predicted image formed by the curved surface using a curved surface parameter indicative of a curved surface approximating a pixel value of a process target block of the image data; and an arithmetic means that adds the predicted image generated by the curved surface generation means to the differential data obtained through decoding by the decoding means.

The curved surface generation means generates the curved surface, by subjecting to inverse orthogonal transform, a curved surface block having as a component the curved surface parameter generated by orthogonally transforming a direct-current component block formed by a direct-current component of coefficient data of the orthogonally transformed process target block.

The curved surface generation means can form a curved surface block with the same size as an in-screen prediction block size for use in in-screen prediction, thereby to subject the curved surface block of the same block size as the in-screen prediction block size to inverse orthogonal transform.

The curved surface size block can have a curved surface parameter and 0 as components.

The in-screen prediction block size can be 8×8, and the direct-current component block size can be 2×2.

The image processing device further includes: an inverse quantization means that inversely quantizes the differential data; and an inverse orthogonal transform means that subjects the differential data inversely quantized by the inverse quantization means, to inverse orthogonal transform. The arithmetic means can add the predicted image to the differential data subjected to inverse orthogonal transform by the inverse orthogonal transform means.

The image processing device further includes a reception means receiving the coded data and the curved surface parameters, and the curved surface generation means can generate the predicted images using the curved surface parameters received by the reception means.

The curved surface parameter is coded. The decoding means can further include a decoding means decoding the coded curved surface parameter.

The curved surface generation means includes: an 8×8 block generation means that generates an 8×8 block using the curved surface parameter; and an inverse orthogonal transform means that subjects the 8×8 block generated by the 8×8 block generation means to inverse orthogonal transform.

Another aspect of the invention is an image processing method used by an image processing device, in which a decoding means of the image processing device decodes coded data formed by coding differential data between image data and a predicted image subjected to intra prediction using the image data; a curved surface generation means of the image processing device generates the predicted image formed by the curved surface using a curved surface parameter indicative of a curved surface approximating a pixel value of a process target block of the image data; and an arithmetic means of the image processing device adds the predicted image generated to the differential data obtained through decoding.

In one aspect of the invention, a curved surface parameter indicative of a curved surface approximating a pixel value of a process target block of image data to be subjected to in-screen coding, is generated using the pixel value of the process target block; the curved surface represented by the curved surface parameter is generated as a predicted image; the pixel value of the curved surface generated as the predicted image is subtracted from the pixel value of the process target block, thereby to generate differential data; and the generated differential data is coded.

In another aspect of the invention, coded data formed by coding differential data between image data and a predicted image subjected to intra prediction using the image data, is decoded; the predicted image formed by the curved surface is generated using a curved surface parameter indicative of a curved surface approximating a pixel value of a process target block of the image data; and the generated predicted image is added to the differential data obtained through decoding.

### Effects of the Invention

According to the invention, it is possible to perform coding of image data or decoding of coded image data, and in particular, it is possible to further improve coding efficiency.

### BRIEF DESCRIPTION OF DRAWINGS

FIG. 1 is a block diagram showing a main configuration example of an image coding device to which the invention is applied.

FIG. 2 is a diagram showing examples of macro blocks.

FIG. 3 is a block diagram showing a main configuration example of an intra prediction part.

FIG. 4 is a diagram for describing an example of state of orthogonal transform.

FIG. 5 is a diagram showing examples of 4×4-pixel intra prediction modes.

FIG. 6 is a diagram showing examples of 8×8-pixel intra prediction modes.

FIG. 7 is a diagram showing examples of 16×16-pixel intra prediction modes.

FIG. 8 is a block diagram showing a main configuration example of a curved surface predicted image generation part.

FIG. 9 is a diagram showing examples of approximate curved surfaces.

FIG. 10 is a block diagram showing a main configuration example of an entropy coding part.

FIG. 11 is a flowchart for describing an example of a flow of a coding process.

FIG. 12 is a flowchart for describing an example of a flow of a prediction process.

FIG. 13 is a flowchart for describing an example of a flow of an intra prediction process.

FIG. 14 is a flowchart for describing an example of a flow of a predicted image generation process.

FIG. 15 is a block diagram showing a main configuration example of an image decoding device to which the invention is applied.

FIG. 16 is a block diagram showing a main configuration example of an intra prediction part.

FIG. 17 is a flowchart for describing an example of a flow of a decoding process.

FIG. 18 is a flowchart for describing an example of a flow of a prediction process.

FIG. 19 is a flowchart for describing an example of a flow of an intra prediction process.

FIG. 20 is a diagram showing other examples of micro blocks.

FIG. 21 is a block diagram showing a main configuration example of a personal computer to which the invention is applied.

FIG. 22 is a block diagram showing a main configuration example of a television receiver to which the invention is applied.

FIG. 23 is a block diagram showing a main configuration example of a cellular phone to which the invention is applied;

FIG. 24 is a block diagram showing a main configuration example of a hard disc recorder to which the invention is applied.

FIG. 25 is a block diagram showing a main configuration example of a camera to which the invention is applied.

### MODE FOR CARRYING OUT THE INVENTION

Embodiments for carrying out the invention (hereinafter, referred to as embodiments) will be described below. The embodiments will be presented in the following order:

1. First embodiment (image coding device)

2. Second embodiment (image decoding device)

3. Third embodiment (personal computer)

4. Fourth embodiment (television receiver)

5. Fifth embodiment (cellular phone)

6. Sixth embodiment (hard disc recorder)

7. Seventh embodiment (camera)

### 1. First Embodiment

### [Image Coding Device]

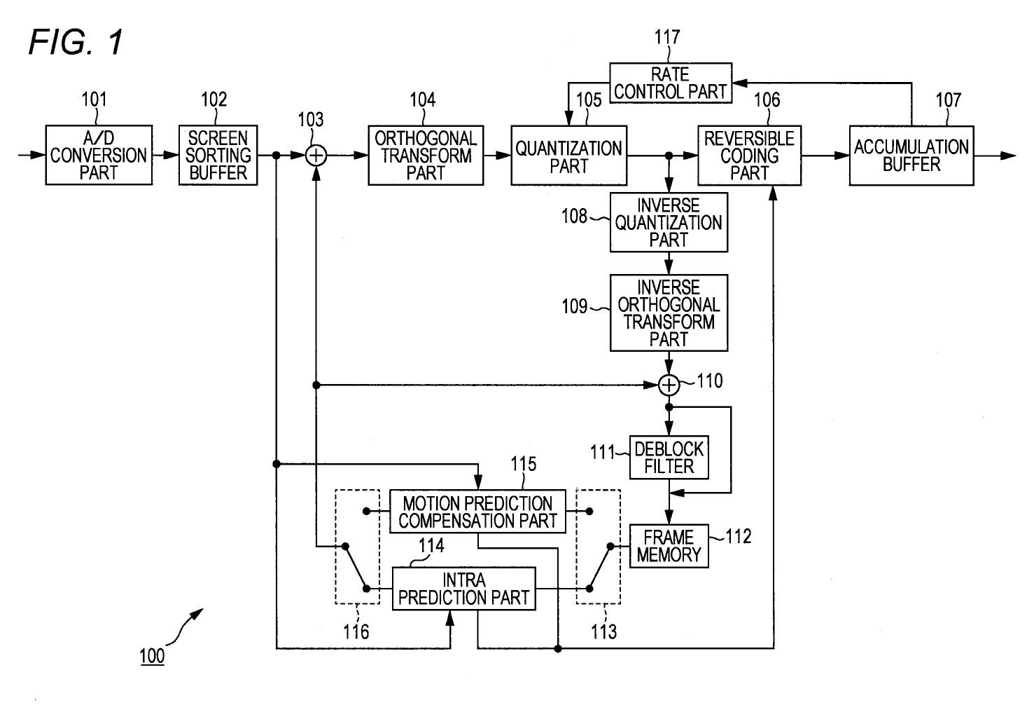

FIG. 1 shows a configuration of one embodiment of an image coding device as an image processing device to which the invention is applied.

An image coding device 100 shown in FIG. 1 is a coding device that subjects an image to compression coding in the H.264 and Moving Picture Experts Group (MPEG) 4 Part 10 (Advanced Video Coding (AVC)) (hereinafter, referred to as H.264/AVC) scheme, for example. However, the image coding device 100 also has, as one of intra decoding modes, a mode of prediction using a curved surface generated from image data before coding, not from a decoded reference image.

In the example of FIG. 1, the image coding device 100 has an analog/digital (A/D) conversion part 101, a screen sorting buffer 102, an arithmetic part 103, an orthogonal transform part 104, a quantization part 105, a reversible coding part 106, and an accumulation buffer 107. In addition, the image coding device 100 has a reverse quantization part 108, a reverse orthogonal transform part 109, and an arithmetic part 110. The image coding device 100 also has a deblock filter 111 and a frame memory 112. The image coding device 100 further has a selection part 113, an intra prediction part 114, a motion prediction compensation part 115, and a selection part 116. Moreover, the image coding device 100 has a rate control part 117.

The A/D conversion part 101 subjects input image data to A/D conversion, and outputs the data to the screen sorting buffer 102 for storage. The screen sorting buffer 102 changes the sorting of frames of stored images from the order of display to the order of coding, according to a Group of Picture (GOP) structure. The screen sorting buffer 102 supplies the image of frames changed in the sorting order to the arithmetic part 103, the intra prediction part 114, and the motion prediction compensation part 115.

The arithmetic part 103 subtracts predicted images supplied from the selection part 116, from images read from the screen sorting buffer 102, and outputs differential information to the orthogonal transform part 104. For example, in the case of images to be subjected to intra coding, the arithmetic part 103 adds predicted images supplied from the prediction part 114 to images read from the screen sorting buffer 102. In addition, for example, in the case of images to be subjected to inter coding, the arithmetic part 103 adds predicted images supplied from the motion prediction compensation part 115 to images read from the screen sorting buffer 102.

The orthogonal transform part 104 subjects differential information from the arithmetic part 103 to orthogonal transform such as discrete cosine transform and Karhunen-Loeve transform, and supplies a coefficient of the transform to the quantization part 105. The quantization part 105 quantizes the coefficient of the transform output from the orthogonal transform part 104. The quantization part 105 supplies the quantized coefficient to the reversible coding part 106.

The reversible coding part 106 subjects the quantized transform coefficient to reversible coding such as variable-length coding and arithmetic coding.

The reversible coding part 106 acquires information indicative of intra prediction, parameters related to an approximate curved surface described later (curved surface parameters), and the like, from the intra prediction part 114, and acquires information indicative of an inter prediction mode from the motion prediction compensation part 115. The information indicative of intra prediction will be hereinafter also referred to as intra prediction mode information. The information on an information mode indicative of an inter prediction mode will be hereinafter also referred to as inter prediction mode information.

The reversible coding part 106 encodes the quantized transform coefficient, and sets a filter coefficient, intra prediction mode information, inter prediction mode information, quantization parameters, and curved surface parameters, and the like, as part of header information of coded data (multiplexing). The reversible coding part 106 supplies coded data obtained through coding to the accumulation buffer 107 for accumulation.

For example, the reversible coding part 106 performs a reversible coding process such as variable-length coding or arithmetic coding. The variable-length coding may be Context-Adaptive Variable Length Coding (CAVLC) defined by the H.264/AVC scheme, or the like. The arithmetic coding may be Context-Adaptive Binary Arithmetic Coding (CABAC) or the like.

The accumulation buffer 107 temporarily holds the coded data supplied from the reversible coding part 106, and outputs the data as coded images coded in the H.264/AVC scheme, to a recording device or a transfer path (not shown) in the subsequent stage, for example, at a predetermined timing.

In addition, the transform coefficient quantized by the quantization part 105 is also supplied to the inverse quantization part 108. The inverse quantization part 108 inversely quantizes the quantized transform coefficient using a method corresponding to the quantization by the quantization part 105, and supplies the obtained transform coefficient to the inverse orthogonal transform part 109.

The inverse orthogonal transform part 109 subjects the supplied transform coefficient to inverse orthogonal transform using a method corresponding to the orthogonal transform process by the orthogonal transform part 104. The output of the inverse orthogonal transform is supplied to the arithmetic part 110.

The arithmetic part 110 adds predicted images supplied from the selection part 116 to the result of the inverse orthogonal transform supplied from the inverse orthogonal transform part 109, that is, to the restored differential information, thereby obtaining locally decoded images (decoded images). For example, if the differential information corresponds to images to be subjected to intra coding, the arithmetic part 110 adds predicted images supplied from the intra prediction part 114 to the differential information. In addition, if the differential information corresponds to images to be subjected to inter coding, for example, the arithmetic part 110 adds predicted images supplied from the motion prediction compensation part 115 to the differential information.

The result of the addition is supplied to the deblock filter 111 or the frame memory 112.

The deblock filter 111 performs a deblock filtering process as appropriate to remove a block distortion from the decoded images, and performs a loop filtering process as appropriate using a Wiener filter, for example, thereby achieving improvement of image quality. The deblock filter 111 classifies the pixels into classes, and performs an appropriate filtering process for each of the classes. The deblock filter 111 supplies the result of the filtering process to the frame memory 112.

The frame memory 112 outputs accumulated reference images via the selection part 113 to the intra prediction part 114 or the motion prediction compensation part 115, at a predetermined timing.

In the case of images to be subjected to intra coding, for example, the frame memory 112 supplies reference images via the selection part 113 to the intra prediction part 114. In the case of images to be subjected to inter coding, for example, the frame memory 112 supplies reference images via the selection part 113 to the motion prediction compensation part 115.

In the image coding device 100, for example, an I picture, a B picture, and a P picture from the screen sorting buffer 102 are supplied as image to be subjected to intra prediction (also called intra processing) to the intra prediction part 114. In addition, the B picture and the P picture read from the screen sorting buffer 102 are supplied as images to be subjected to inter prediction (also called inter processing) to the motion prediction compensation part 115.

If the reference images supplied from the frame memory 112 are to be subjected to intra coding, the selection part 113 supplies the images to the intra prediction part 114, and if the images are to be subjected to inter coding, the selection part 113 supplies the images to the motion prediction compensation part 115.

The intra prediction part 114 performs intra prediction (in-screen prediction) for generating predicted images using pixel values in a screen. The intra prediction part 114 performs intra prediction in a plurality of modes (intra prediction modes).

The intra prediction modes include a mode for generating predicted images based on reference images supplied from the frame memory 112 via the selection part 113. The intra prediction modes also include a mode for generating predicted images using images to be subjected to intra prediction (pixel values of process target blocks) read from the screen sorting buffer 102.

The intra prediction part 114 generates predicted images in all of the intra prediction modes, evaluates each of the predicted images, and selects an optimum mode. Upon selection of the optimum intra prediction mode, the intra prediction part 114 supplies the predicted images generated in the optimum mode to the arithmetic part 103 via the selection part 116.

In addition, as described above, the intra prediction part 114 provides the reversible coding part 106 as appropriate with intra prediction mode information indicative of the employed intra prediction mode and information such as curved surface parameters of the predicted images.

For images to be subjected to inter coding, the motion prediction compensation part 115 calculates a motion vector, using input images supplied from the screen sorting buffer 102 and decoded images as reference frames supplied from the frame memory 112 via the selection part 113. The motion prediction compensation part 115 performs a motion compensation process according to the calculated motion vector, thereby to generate predicted images (inter predicted image information).

The motion prediction compensation part 115 performs an inter prediction process in all of candidate inter prediction modes, thereby to generate predicted images. The motion prediction compensation part 115 supplies the generated predicted images to the arithmetic part 103 via the selection part 116.

The motion prediction compensation part 115 provides the reversible coding part 106 with inter prediction mode information indicative of the employed inter prediction mode and motion vector information indicative of the calculated motion vector.

In the case of images to be subjected to intra coding, the selection part 116 supplies output from the intra prediction part 114 to the arithmetic part 103, and in the case of images to be subjected to inter coding, the selection part 116 supplies output from the motion prediction compensation part 115 to the arithmetic part 103.

The rate control part 117 controls the rate of a quantization operation by the quantization part 105 so as to prevent occurrence of an overflow or an underflow, based on compressed images accumulated in the accumulation buffer 107.

### [Macro Blocks]

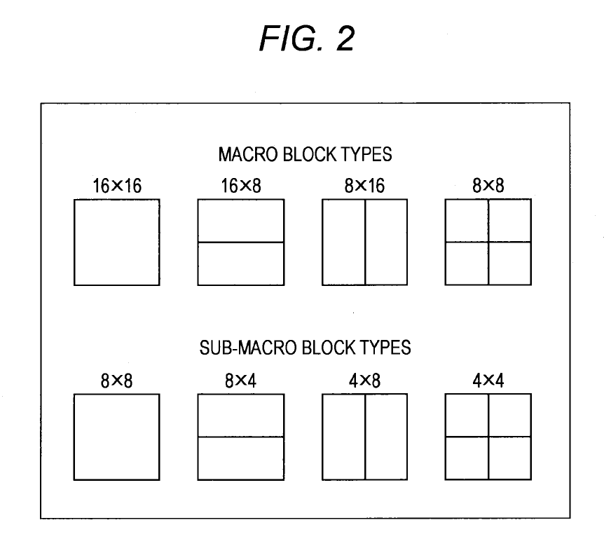

FIG. 2 is a diagram showing examples of block sizes for motion prediction compensation in the H.264/AVC scheme. In the H.264/AVC scheme, motion prediction compensation is carried out with a variable block size.

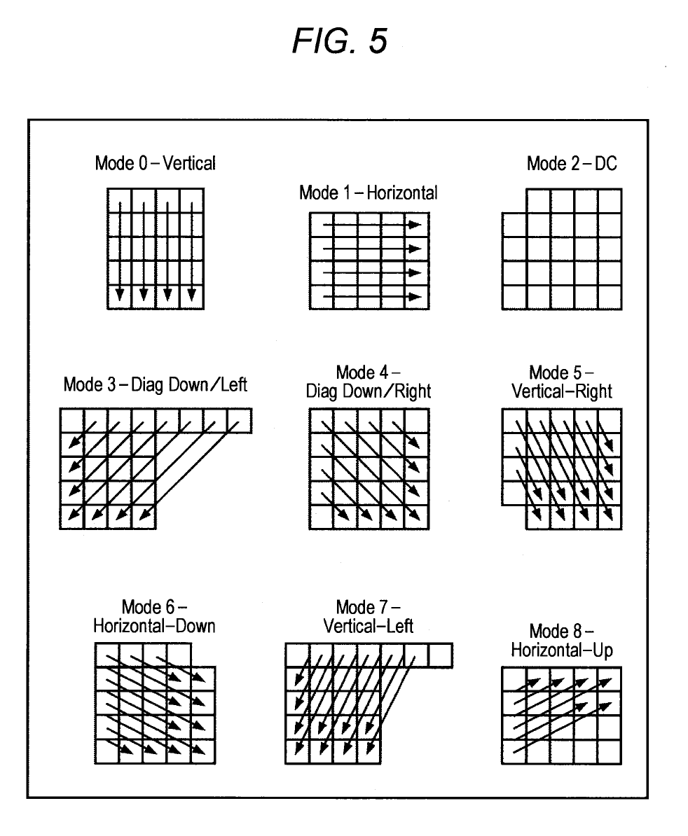

FIG. 2 shows on the upper part macro blocks formed by 16×16 pixels, which are divided into partitions of 16×16 pixels, 16×8 pixels, 8×16 pixels, and 8×8 pixels, in sequence from the left. FIG. 5 shows on the lower part sub-macro blocks formed by 8×8 pixels, which are divided into partitions of 8×8 pixels, 8×4 pixels, 4×8 pixels, and 4×4 pixels, in sequence from the left.

Specifically, in the H.264/AVC scheme, one macro block can be divided into any of partitions of 16×16 pixels, 16×8 pixels, 8×16 pixels, and 8×8 pixels, each of which includes independent motion vector information. The partition of 8×8 pixels can be divided into any of sub-partitions 8×8 pixels, 8×4 pixels, 4×8 pixels, or 4×4 pixels, each of which includes independent motion vector information.

### [Intra Prediction Part]

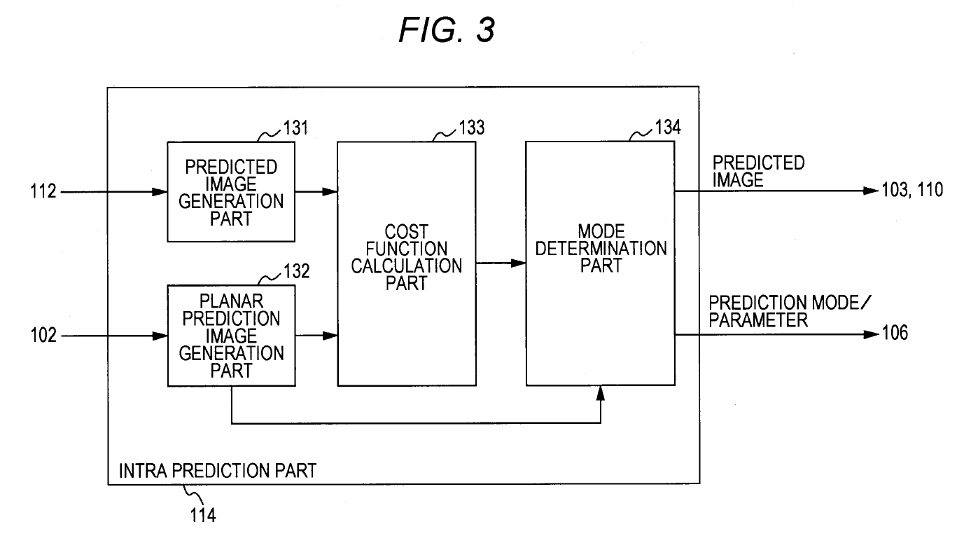

FIG. 3 is a block diagram showing a main configuration example of the intra prediction part 114 shown in FIG. 1.

As shown in FIG. 3, the intra prediction part 114 has a predicted image generation part 131, a curved surface predicted image generation part 132, a cost function calculation part 133, and a mode determination part 134.

As described above, the intra prediction part 114 has both the mode for generating predicted images using reference images (peripheral pixels) acquired from the frame memory 112 and the mode for generating predicted images using process target images. The predicted image generation part 131 generates predicted images in the mode using the reference images (peripheral pixels) acquired from the frame memory 112.

Meanwhile, the curved surface predicted image generation part 132 generates predicted images in the mode using process target images. More specifically, the curved surface predicted image generation part 132 approximates pixel values of the process target images in a curved surface, and sets the approximate curved surface as predicted images.

The predicted images generated by the predicted image generation part 131 or the curved surface predicted image generation part 132 are supplied to the cost function calculation part 133.

The cost function calculation part 133 calculates cost function values of the predicted images generated by the predicted image generation part 131 in the intra prediction modes of 4×4 pixels, 8×8 pixels, and 16×16 pixels. The cost function calculation part 133 also calculates cost function values of the predicted images generated by the curved surface predicted image generation part 132.

Here, the cost function values are calculated in High Complexity mode or Low Complexity mode. These modes are defined by Joint Model (JM) as reference software in the H.264/AVC scheme.

Specifically, in High Complexity mode, it is assumed that the processes up to a coding process are performed in all of the candidate prediction modes. Then, cost function values expressed by the following equation (1) are calculated in the respective prediction modes, and the prediction mode with the smallest cost function value is selected as an optimum prediction mode.

Cost(Mode)=D+λ·R (1)

In the equation (1), D denotes a difference between an original image and a decoded image (distortion); R denotes an amount of generated codes including up to the orthogonal transform coefficient; and λ denotes a Lagrange multiplier given as a function of a quantization parameter QP.

Meanwhile, in Low Complexity mode, generation of predicted images and calculation of header bits including motion vector information, prediction mode information, and flag information, are performed in all of the candidate prediction modes. Then, cost function values expressed by the following equation (2) are calculated in all of the prediction modes, and the prediction mode with the smallest cost function value is selected as an optimum prediction mode.

Cost(Mode)=D+QPtoQuant(QP)·Header_Bit (2)

In the equation (2), D denotes a difference between an original image and a decoded image (distortion), Header_Bit denotes a header bit for the prediction mode, and QPtoQuant denotes a function of the quantization parameter QP.

In Low Complexity mode, predicted images are merely generated in all of the prediction modes, but there is no need to perform a coding process or a decoding process, which results in a smaller amount of arithmetic operation.

The cost function calculation part 133 supplies the thus calculated cost function values to the mode determination part 134. The mode determination part 134 selects the optimum intra prediction mode according to the supplied cost function values. Specifically, the mode determination part 134 selects the intra prediction mode with the smallest cost function value as the optimum intra prediction mode.

The mode determination part 134 supplies the predicted images in the prediction mode selected as the optimum intra prediction mode, to the arithmetic part 103 and the arithmetic part 110 via the selection part 116 as necessary. The mode determination part 134 also supplies information of the prediction mode to the reversible coding part 106 as necessary.

Further, if the prediction mode of the curved surface predicted image generation part 132 is selected as the optimum intra prediction mode, the mode determination part 134 acquires curved surface parameters from the curved surface predicted image generation part 132, and supplies the parameters to the reversible coding part 106.

### [Orthogonal Transform]

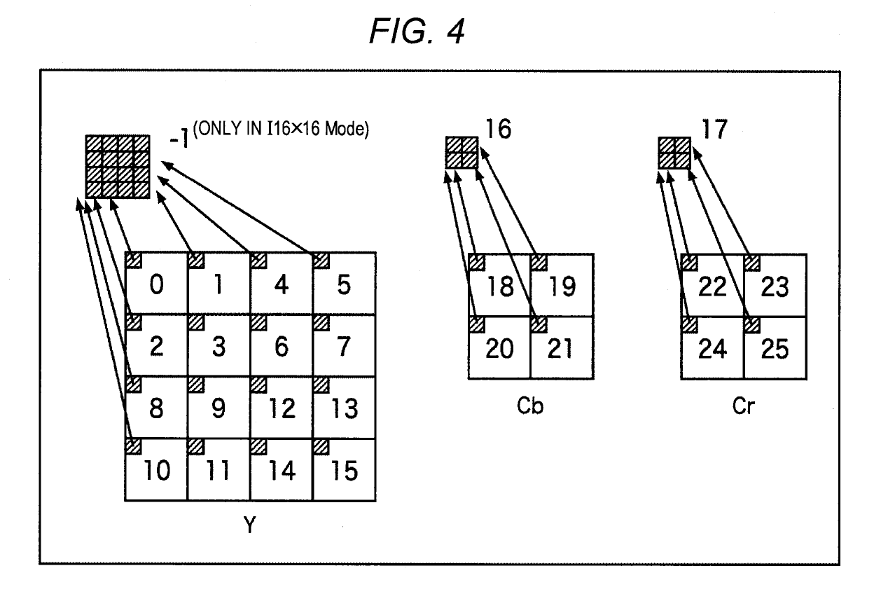

FIG. 4 is a diagram for describing an example of states of orthogonal transform.

In the example shown in FIG. 4, numbers −1 to 25 given to blocks denote the bit stream order of the blocks (the processing order on the decoding side). In the case of a brightness signal, macro blocks are divided into 4×4 pixels, and 4×4-pixel DCT is carried out. In addition, only in the case of the intra 16×16 prediction mode, direct-current components from all of the blocks are collected to generate a 4×4 matrix, as shown by −1 block, and orthogonal transform is further performed.

Meanwhile, in the case of a color-difference signal, the macro blocks are divided into 4×4 pixels, 4×4-pixel DCT is performed, and then direct-current components from the blocks are collected to generate a 2×2 matrix, as shown by blocks 16 and 17 in FIG. 4. Then, orthogonal transform is further performed.

The foregoing matters are applicable in the intra 8×8 prediction mode, only to the case where 8×8 orthogonal transform is performed on target macro blocks in a high profile or a more profile.

### [Intra Prediction Mode]

Here, a prediction process by the predicted image generation part 131 will be described. In AVC defined by the H.264/AVC scheme, the predicted image generation part 131 performs intra prediction in three modes: the intra 4×4 prediction mode, the intra 8×8 prediction mode, and the intra 16×16 prediction mode. The modes are intended to define the unit of block and are set for each macro block. In addition, the intra prediction mode for color-difference signals can be set independently from that for brightness signals, for each macro block.

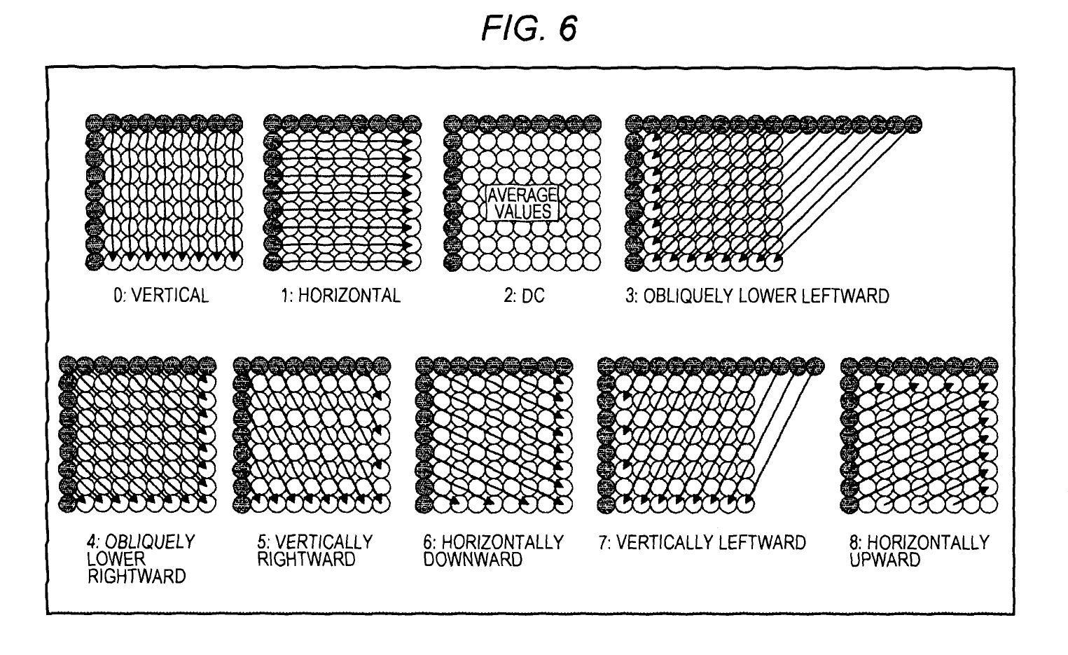

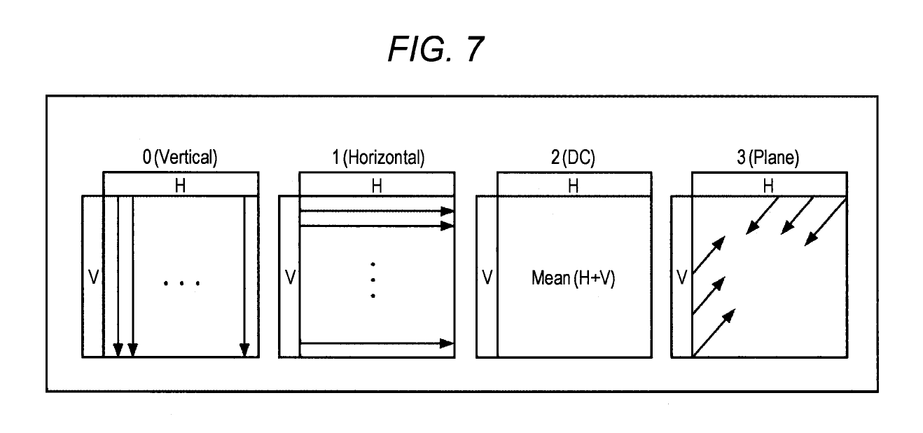

Further, in the case of the intra 4×4 prediction mode, as shown in FIG. 5, one of nine prediction modes can be set for each target block of 4×4 pixels. In the case of the intra 8×8 prediction mode, as shown in FIG. 6, one of nine prediction modes can be set for each target block of 8×8 pixels. In the case of the intra 16×16 prediction mode, as shown in FIG. 7, one of four prediction modes can be set for each target block of 16×16 pixels.

The intra 4×4 prediction mode, the intra 8×8 prediction mode, and the intra 16×16 prediction mode, will also be called as appropriate 4×4-pixel intra prediction mode, 8×8-pixel intra prediction mode, and 16×16-pixel intra prediction mode.

FIG. 7 is a diagram showing four kinds of 16×16-pixel intra prediction modes (Intra_{—}16×16_pred_mode) for brightness signals.

A target macro block to be subjected to an intra process is designated as A, and P(x, y); x, y=−1, 0, . . . , 15 are set as pixel values of pixels adjacent to the target macro block A.

The mode 0 is a vertical prediction mode, which is applied only when P(x, −1); x, y=−1, 0, . . . , 15 is “available.” In this case, a predicted pixel value Pred(x, y) of each pixel of the target macro block A is generated as in the following equation (3):

Pred(x,y)=P(x,−1); x,y=0, . . . , 15 (3)

The mode 1 is a horizontal prediction mode, which is applied only when P(−1, y); x, y=−1, 0, . . . , 15 is “available.” In this case, a predicted pixel value Pred(x, y) of each pixel of the target macro block A is generated as shown in the following equation (4):

Pred(x,y)=P(−1,y); x,y=0, . . . , 15 (4)

The mode 2 is a DC prediction mode, and if P(x, −1) and P(−1, y); x, y=−1, 0, . . . 15 are all “available,” a predicted pixel value Pred(x, y) of each pixel of the target macro block A is generated as in the following equation (5):

$$\begin{matrix} [ Equation 1 ] & \\ Pred ( x , y ) = [ {\sum }_{{x}^{′} = 0}^{15} P ( {x}^{′} , - 1 ) + {\sum }_{{y}^{′} = 0}^{15} P ( - 1 , {y}^{′} ) + 16 ] >> 5 with x , \\ y = 0 , … , 15 & ( 5 )\end{matrix}$$

In addition, if P(x, −1); x, y=−1, 0, . . . , 15 is “unavailable,” a predicted pixel value Pred(x, y) of each pixel of the target macro block A is generated as in the following equation (6):

$$\begin{matrix}[ Equation 2 ] & \\ Pred ( x , y ) = [ {\sum }_{{y}^{′} = 0}^{15} P ( - 1 , {y}^{′} ) + 8 ] >> 4 with x , \\ y = 0 , … , 15 & ( 6 )\end{matrix}$$

If P(−1, y); x, y=−1, 0, . . . , 15 is unavailable, a predicted pixel value Pred(x, y) of each pixel of the target macro block A is generated as in the following equation (7):

$$\begin{matrix}[ Equation 3 ] & \\ Pred ( x , y ) = [ {\sum }_{{y}^{′} = 0}^{15} P ( {x}^{′} , - 1 ) + 8 ] >> 4 with x , \\ y = 0 , … , 15 & ( 7 )\end{matrix}$$

If P(x, −1) and P(−1, y); x, y=−1, 0, . . . , 15 are all “unavailable,” the prediction pixel value 128 is used.

The mode 3 is a Plane Prediction mode, which is applied only when P(x, −1) and P(−1, y); x, y=−1, 0, . . . , 15 are all “available.” In this case, a prediction pixel value Pred(x, y) of each pixel of the target macro block A is generated as in the following equation (8):

$$\begin{matrix}[ Equation 4 ] & \\ Pred ( x , y ) = Clip 1 ( ( a + b \cdot ( x - 7 ) + c \cdot ( y - 7 ) + 16 ) >> 5 ) \\ a = 16 \cdot ( P ( - 1 , 15 ) + P ( 15 , - 1 ) ) \\ b = ( 5 \cdot H + 32 ) >> 6 \\ c = ( 5 \cdot V + 32 ) >> 6 \\ H = {\sum }_{x = 1}^{8} x \cdot ( P ( 7 + x , - 1 ) - P ( 7 - x , - 1 ) ) \\ V = {\sum }_{y = 1}^{8} y \cdot ( P ( - 1 , 7 + y ) - P ( - 1 , 7 - y ) ) & ( 8 )\end{matrix}$$

The intra prediction mode for color-difference signals can be set independently from the intra prediction mode for brightness signals. The intra prediction mode for color-difference signals conforms to the 16×16-pixel intra prediction mode for brightness signals described above.

However, the 16×16-pixel intra prediction mode for brightness signals is targeted for 16×16-pixel blocks, whereas the intra prediction mode for color-difference signals is targeted for 8×8-pixel blocks.

As described in the foregoing, the intra prediction modes for brightness signals include nine kinds of prediction modes in block units of 4×4 pixels and 8×8 pixels, and four kinds of prediction modes in block units of 16×16 pixels. The block-unit modes are set for each macro block unit. The intra prediction modes for color-difference signals include four kinds of prediction modes in block units of 8×8 pixels. The intra prediction modes for color-difference signals can be set independently from the intra prediction modes for brightness signals.

With regard to the 4×4-pixel intra prediction modes for brightness signals (intra 4×4 prediction modes) and 8×8-pixel intra prediction modes (intra 8×8 prediction modes), one intra prediction mode is set for each 4×4-pixel block and 8×8-pixel block of brightness signals. With regard to the 16×16-pixel intra prediction modes for brightness signals (intra 16×16 prediction modes) and the intra prediction mode for color-difference signals, one prediction mode is set for one macro block.

### [Curved Surface Predicted Image Generation Part]

In the mode 3 (Plane Prediction mode) of the 16×16-pixel intra prediction modes, a plane of process target blocks is predicted from a small number of pixels neighboring the process target blocks. The neighboring pixel values use pixel values of reference images supplied from the frame memory 112. Further, pixel values of decoded images are used in a decoding process. Therefore, this mode provides no high prediction accuracy and may lower coding efficiency.

Meanwhile, the curved surface predicted image generation part 132 makes a prediction using pixel values of process target blocks of input images (original images). In addition, the curved surface predicted image generation part 132 approximates actual pixel values as a prediction by a curved surface. Accordingly, the curved surface predicted image generation part 132 improves prediction accuracy and enhances coding efficiency. In this case, however, the original images cannot be obtained on the decoding side, and thus parameters indicative of a predicted curved surface (curved surface parameter) are also transferred to the decoding side.

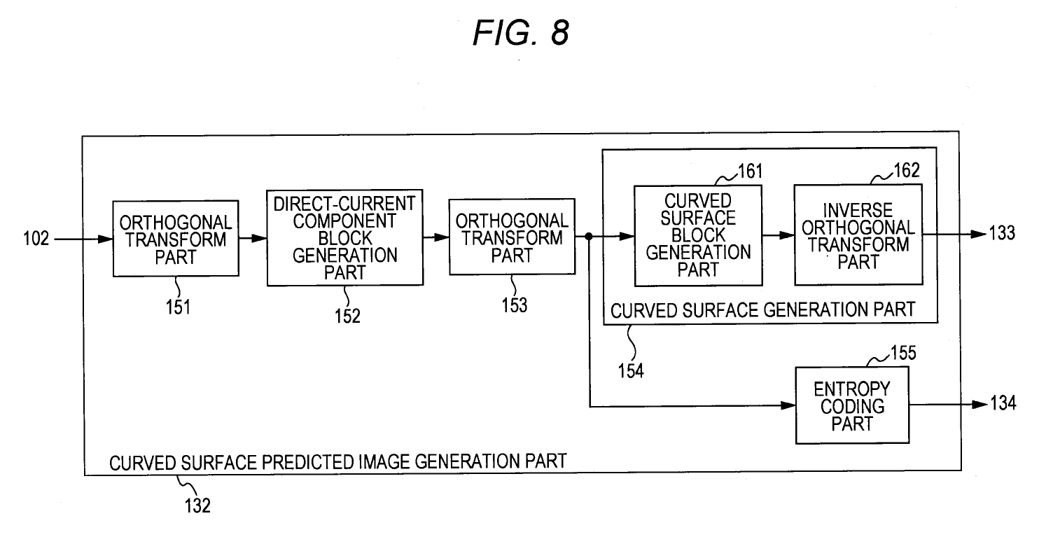

FIG. 8 is a block diagram showing a main configuration example of the curved surface predicted image generation part 132 shown in FIG. 3.

As shown in FIG. 8, the curved surface predicted image generation part 132 has an orthogonal transform part 151, a direct-current component block generation part 152, an orthogonal transform part 153, a curved surface generation part 154, and an entropy coding part 155.

The orthogonal transform part 151 orthogonally transforms pixel values of the process target blocks of the input images supplied from the screen sorting buffer 102, in each predetermined size. That is, the orthogonal transform part 151 divides the process target blocks into a predetermined number of portions, and subjects the blocks to orthogonal transform. The orthogonal transform part 151 supplies the orthogonally transformed coefficient data to the direct-current component block generation part 152.

The direct-current component block generation part 152 extracts direct-current components from a group of orthogonally transformed coefficient data, and generates direct-current component blocks of a predetermined size using the extracted components. That is, the direct-current component blocks are formed by direct-current components of the process target blocks. The direct-current component block generation part 152 supplies the generated direct-current component blocks to the orthogonal transform part 153.

The orthogonal transform part 153 further subjects the direct-current component blocks to orthogonal transform. The orthogonal transform part 153 supplies the generated coefficient data to the curved surface generation part 154 and the entropy coding part 155.

The curved surface generation part 154 generates a curved surface approximating pixel values of the process target blocks using the direct-current component blocks orthogonally transformed by the orthogonal transform part 153.

The curved surface generation part 154 has a curved surface block generation part 161 and an inverse orthogonal transform part 162. The curved surface generation part 161 generates a block (curved surface block) of the same size as the process target blocks, using blocks of coefficient data (called curved surface parameters described later) obtained by orthogonal transform of the direct-current component blocks. In the curved surface block, a low-pass component of the direct-current components is occupied by the curved surface parameters in a block size of the curved surface parameters. In addition, the other part of the curved surface block is set at the coefficient value of “0.” That is, the curved surface block has a curved surface parameter block arranged at the upper left side and the other part with a coefficient of “0”, and is the same in size as the process target block. Incidentally, the direct-current component of the curved surface parameter block constitutes a direct-current component of the curved surface block. The curved surface generation part 161 supplies the generated curved surface block to an inverse orthogonal transform part 162.

The inverse orthogonal transform part 162 subjects the supplied curved surface blocks to inverse orthogonal transform. The pixel values of the curved surface blocks subjected to inverse orthogonal transform form a curved surface. The curved surface is set as an approximate curved surface (that is, predicted images). The inverse orthogonal transform part 162 supplies the inversely orthogonally transformed curved surface blocks to the cost function calculation part 133.

The entropy coding part 155 subjects the direct-current component blocks (that is, curved surface parameters) orthogonally transformed by the orthogonal transform part 153 to entropy coding. This coding reduces a data amount of the curved surface parameters. The entropy coding part 155 supplies the generated coded data to the mode determination part 134.

### [Approximate Curved Surface]

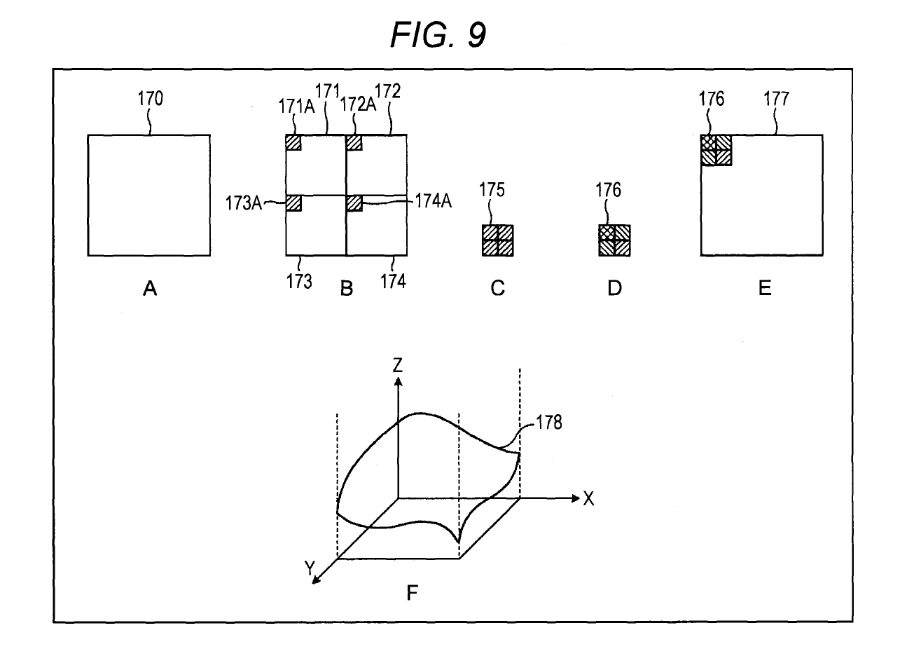

First, approximation with a curved surface will be described. FIG. 9 is a diagram showing an example of an approximate curved surface.

The orthogonal transform part 151 divides an 8×8 process target block 170 as shown in FIG. 9A, for example, into four 4×4 blocks as shown in FIG. 9B, for example, and subjects the blocks to orthogonal transform. The direct-current component block generation part 152 extracts direct-current components 171A to 174A as coefficients at the upper left ends from the orthogonally transformed coefficient data 171 to 174, and collects the components to generate a 2×2 direct-current component block 175 as shown in FIG. 9C.

Positions of the coefficients in the direct-current component block 175 remain unchanged from those shown in FIG. 9B: the direct-current component 171A is positioned at the upper left side; the direct-current component 172A at the upper right side; the direct-current component 173A at the lower left side; and the direct-current component 174A at the lower right side.

The direct-current component block 175 shows direct-current components in four regions: upper left, upper right, lower left, and lower right regions of the process target block 170. That is, the direct-current component block 175 shows low-frequency components of the entire process target block 170.

The orthogonal transform part 153 further orthogonally transforms the direct-current component block 175. A 2×2 block 176 shown in FIG. 9D is formed by orthogonally transforming the direct-current component block 175.

The curved surface generation part 161 generates an 8×8 curved surface block 177 as shown in FIG. 9E. As described above, an upper left end (low-pass component) of the curved surface block 177 is formed by a 2×2 block of curved surface parameters, and the other part is occupied by the coefficient value of “0.”

In other words, the curved surface block 177 shown in FIG. 9E is a coefficient data block including only the block 176 obtained through orthogonal transform of the direct-current component block. That is, the curved surface block 177 is coefficient data including only the low-frequency component of the process target block 170.

The inverse orthogonal transform part 162 generates a curved surface 178 as shown in FIG. 9F by subjecting the curved surface block 177 to inverse orthogonal transform. The curved surface 178 is a curved surface including only the low-frequency component of the process target block 170, which is used as predicted images of the process target.

In a plane mode of the intra prediction mode, prediction is performed in a plane surface, and is limited to an extent that mere trends of changes in pixel values of the entire process target block can be grasped.

Meanwhile, the curved surface predicted image generation part 132 makes a prediction by a curved surface generated using a method as shown in FIG. 9, which is larger in degree of freedom than prediction in the plane mode of the intra prediction mode. Therefore, it is possible to grasp finer trends of changes in pixel value of the entire process target block.

However, the curved surface is originally intended for approximation of the entire process target block, and thus it is difficult to correspond to local changes in the process target block by the curved surface 178. Therefore, as described above, the curved surface predicted image generation part 132 can generate an approximate curved surface (predicted images) so as to reduce occurrence of errors due to local changes in pixel value, by removing high-frequency components of pixel values of the process target block.

As in the foregoing, the coefficient data 176 formed by orthogonally transforming the direct-current component block 175 generated by the direct-current component block generation part 152, defines characteristics of the approximate curved surface. Therefore, values of the coefficient data 176 are called curved surface parameters. In the foregoing description, the size of the process target block is set at 8×8, and the orthogonal transform part 151 orthogonally transforms the process target block by 4×4. In addition, the direct-current component block generation part 152 collects direct-current components to generate a 2×2 direct-current component block, and the orthogonal transform part 153 orthogonally transforms the 2×2 direct-current component. Further, the curved surface generation part 161 generates an 8×8 curved surface block of the same size as that of the process target block, and the inverse orthogonal transform part 162 subjects the 8×8 curved surface block to inverse orthogonal transform. However, the sizes of the blocks may be different from the foregoing ones. For example, the size of the process target block may be set at 16×16, the orthogonal transform part 151 orthogonally transform the process target block by 4×4, the direct-current component block generation part 152 collect the direct-current components to generate a 4×4 direct-current component block, the orthogonal transform part 153 orthogonally transform the 4×4 direct-current component block, the curved surface generation part 161 generate a 16×16 curved surface block, and the inverse orthogonal transform part 162 subject the 16×16 curved surface block to inverse orthogonal transform. The sizes of the process target block and the curved surface block are basically arbitrarily decided, and may be 32×32 or larger. In addition, the process target block can be orthogonally transformed by the orthogonal transform part 151 in an arbitrary size within a feasible range. For example, if the size of the process target block is 32×32, the orthogonal transform part 151 may perform orthogonal transform by 4×4, 8×8, or 16×16, or by any other size as a matter of course. The sizes of the direct-current component block and the curved surface parameter block vary depending on the size of the process target block and the orthogonal transform size. That is, the sizes of the direct-current component block and the curved surface parameter block may be any other than 2×2 or 4×4.

### [Entropy Coding Part]

The thus determined curved surface parameters are generated from pixel values of a process target block of a raw image acquired from the screen sorting buffer 102. That is, the curved surface parameters cannot be generated from the decoded image data, and thus it is needed to provide the curved surface parameters to the decoding side.

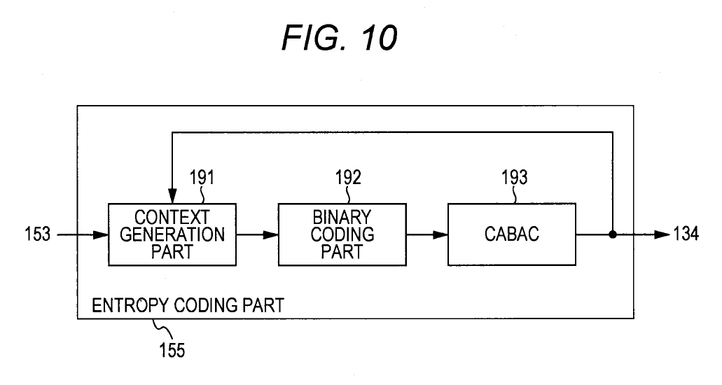

Accordingly, the curved surface parameters are subjected to entropy coding by the entropy coding part 155 so as to be reduced in data amount and capable of being more easily supplied to the decoding side. FIG. 10 is a block diagram of a major configuration example of the entropy coding part 155 shown in FIG. 8.

The entropy coding part 155 has a context generation part 191, a binary coding part 192, and a Context-based Adaptive Binary Arithmetic Coding (CABAC) 193, as shown in FIG. 10, for example.

The context generation part 191 generates one or more contexts, according to results of prediction coding supplied from the orthogonal transform part 153 and state of peripheral blocks, and defines probability model(s) for the context(s).

The binary coding part 192 binarizes a context output from the context generation part 191. The CABAC 193 subjects the binarized context(s) to arithmetic coding. Coded data (coded curved surface parameters) output from the CABAC 193 is supplied to the mode determination part 134. The CABAC 193 also updates the probability model(s) from the context generation part 191, according to results of the coding.

### [Coding Process]

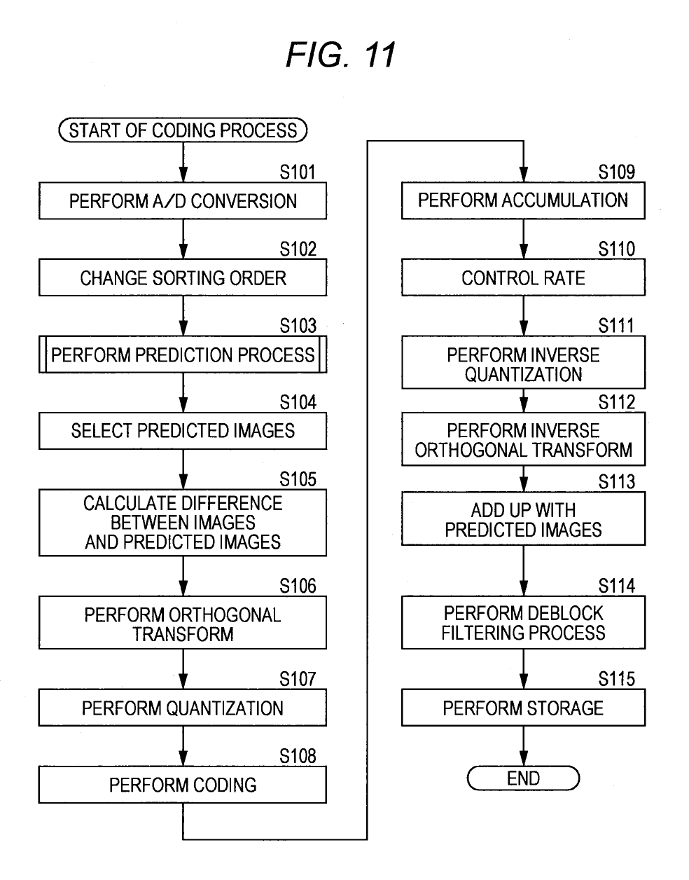

Next, flows of processes performed by the thus configured image coding device 100 will be described. First, an example of a flow of a coding process will be described with reference to a flowchart shown in FIG. 11.

At step S101, the A/D conversion part 101 subjects input images to A/D conversion. At step S102, the screen sorting buffer 102 stores the images supplied from the A/D conversion part 101, and changes the sorting of the images from the order of display of the pictures to the order of coding the pictures.

At step S103, the intra prediction part 114 and the motion prediction compensation part 115 each perform an image prediction process. Specifically, at step S103, the intra prediction part 114 performs an intra prediction process in the intra prediction mode. The motion prediction compensation part 115 performs a motion prediction compensation process in the inter prediction mode.

At step S104, the selection part 116 decides an optimum prediction mode based on cost function values output from the intra prediction part 114 and the motion prediction compensation part 115. Specifically, the selection part 116 selects from either predicted images generated by the intra prediction part 114 or predicted images generated by the motion prediction compensation part 115.

Information on the selection of predicted images is supplied to the intra prediction part 114 or the motion prediction compensation part 115. If the predicted images in the optimum intra prediction mode are selected, the intra prediction part 114 supplies information indicative of the optimum intra prediction mode (that is, intra prediction mode information) to the reversible coding part 106.

Further, if the prediction mode of the curved surface predicted image generation part 132 performing prediction with the use of the original images is selected as the optimum intra prediction mode, the intra prediction part 114 also supplies coding data of the predicted curved surface parameters to the reversible coding part 106.

If the predicted images in the optimum inter prediction mode are selected, the motion prediction compensation part 115 outputs information indicative of the optimum inter prediction mode and, if necessary, information according to the optimum inter prediction mode, to the reversible coding part 106. The information according to the optimum inter prediction mode may include motion vector information, flag information, and reference frame information.

At step S105, the arithmetic part 103 calculates the difference between the images sorted at step S102 and the predicted images acquired by the prediction process at step S103. The predicted images are supplied to the arithmetic part 103 via the selection part 116, from the motion prediction compensation part 115 in the case of inter prediction or from the intra prediction part 114 in the case of intra prediction.

The differential data is reduced in data amount as compared with the original image data. Therefore, the data amount can be compressed as compared with the case where the images are coded as they are.

At step S106, the orthogonal transform part 104 orthogonally transforms the differential information supplied from the arithmetic part 103. Specifically, the orthogonal transform part 104 performs orthogonal transform such as discrete cosine transform or Karhunen-Loeve transform, and outputs a transform coefficient. At step S107, the quantization part 105 quantizes the transform coefficient.

At step S108, the reversible coding part 106 encodes the quantized transform coefficient output from the quantization part 105. Specifically, the reversible coding part 106 subjects the differential images (secondary differential images in the case of the inter prediction) to inverse coding such as variable-length coding or arithmetic coding.

The reversible coding part 106 encodes information relating to the prediction mode for the predicted images selected by the process at step S104, and adds the coded information to head information of coded data obtained by coding the differential images.

Specifically, the reversible coding part 106 also encodes the intra prediction mode information supplied from the intra prediction part 114 or the information according to the optimum inter prediction mode supplied from the motion prediction compensation part 115, and adds the coded information to the header information. In addition, if the coded data of the curved surface parameters is supplied from the intra prediction part 114, the reversible coding part 106 also adds the coded data to the header information of the coded data and the like.

At step S109, the accumulation buffer 107 accumulates the coded data output from the reversible coding part 106. The coded data accumulated in the accumulation buffer 107 is appropriately read and transferred to the decoding side via a transmission path.

At step S110, the rate control part 117 controls the rate of quantization motion by the quantization part 105 so as not to cause an overflow or an underflow, according to the compressed images accumulated in the accumulation buffer 107.

The differential information quantized by the process at step S107 is locally decoded as described below. Specifically, at step S111, the inverse quantization part 108 inversely quantizes the transform coefficient quantized by the quantization part 105, with the use of characteristics corresponding to the characteristics of the quantization part 105. At step S112, the inverse orthogonal transform part 109 subjects the transform coefficient inversely quantized by the inverse quantization part 108 to inverse orthogonal transform, with the use of characteristics corresponding to the characteristics of the orthogonal transform part 104.

At step S113, the arithmetic part 110 adds the predicted images input via the selection part 116 to the locally decoded differential information, thereby to generate locally decoded images (images corresponding to input into the arithmetic part 103). At step S114, the deblock filter 111 filters the images output from the arithmetic part 110, thereby to remove block strains. At step S115, the frame memory 112 stores the filtered images. The frame memory 112 also is supplied with images not filtered by the deblock filter 111 from the arithmetic part 110, and stores the images.

### [Prediction Process]

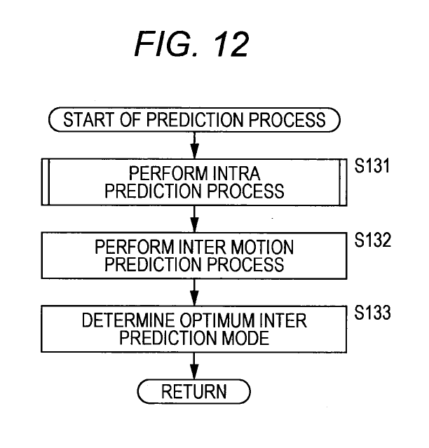

Next, an example of a flow of a prediction process performed at step S103 shown in FIG. 11 will be described with reference to a flowchart shown in FIG. 12.

At step S131, the intra prediction part 114 performs intra prediction on pixels of process target blocks in all of the candidate intra prediction modes. The intra prediction modes include both the mode in which a prediction is made using reference images supplied from the frame memory 112 and the mode in which a prediction is made using original images acquired from the screen sorting buffer 102. If a prediction is made using reference images supplied from the frame memory 112, pixels not subjected to deblock filtering by the deblock filter 111 are used as decoded reference pixels.

If the process target images supplied from the screen sorting buffer 102 are to be subjected to inter process, the reference images are read from the frame memory 112 and supplied to the motion prediction compensation part 115 via the selection part 113. At step S132, the motion prediction compensation part 115 performs an inter motion prediction process according to these images. Specifically, the motion prediction compensation part 115 performs a motion prediction process in all the candidate inter prediction modes, with reference to the images supplied from the frame memory 112.

At step S133, the motion prediction compensation part 115 determines, out of cost function values for the inter prediction modes calculated at step S132, a prediction mode with a smallest value as an optimum inter prediction mode. Then, the motion prediction compensation part 115 supplies a difference between the image to be subjected to an inter process and the secondary differential information generated in the optimum inter prediction mode, and a cost function value in the optimum inter prediction mode, to the selection part 116.

### [Intra Prediction Process]

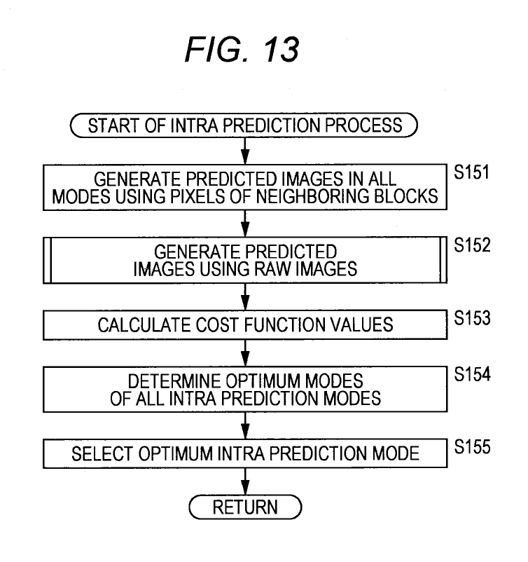

FIG. 13 is a flowchart for describing an example of a flow of an intra prediction process performed at step S131 shown in FIG. 12.

When an intra prediction process is started, at step S151, the predicted image generation part 131 generates predicted images in each of the modes, using pixels of neighboring blocks of the reference images supplied from the frame memory 112.

At step S152, the curved surface predicted image generation part 132 generates predicted images using the original images (raw images) supplied from the screen sorting buffer 102.

At step S153, the cost function calculation part 133 calculates a cost function value for each of the modes.

At step S154, the mode determination part 134 determines optimum modes of the intra prediction modes, according to the cost function values for the modes calculated at step S153.

At step S155, the mode determination part 134 selects the optimum intra prediction mode, according to the cost function values for the modes calculated at step S153.

The mode determination part 134 supplies the predicted images generated in the mode selected as the optimum intra prediction mode, to the arithmetic part 103 and the arithmetic part 110. The mode determination part 134 also supplies information indicative of the selected prediction mode to the reversible coding part 106. Further, in the mode of generating predicted images using the raw images, the mode determination part 134 also supplies coded data of curved surface parameters to the reversible coding part 106.

Upon completion of the process at step S155, the intra prediction part 114 returns to the process shown in FIG. 12 to perform step S132 and the subsequent processes.

### [Predicted Image Generating Process]

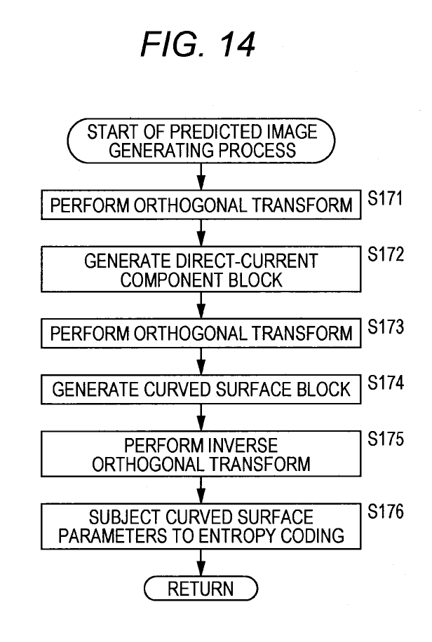

Next, an example of a flow of a predicted image generating process performed at step S152 shown in FIG. 13 will be described with reference to the flowchart in FIG. 14.

When the predicted image generating process is started, at step S171, the orthogonal transform part 151 (FIG. 8) of the curved surface predicted image generation part 132 divides an 8×8 process target block supplied from the screen sorting buffer 102 to four 4×4 blocks, and orthogonally transforms each of the 4×4 blocks.

At step S172, the direct-current component block generation part 152 extracts direct-current components from the 4×4 blocks, and generates a 2×2 direct-current component block including these components.

At step S173, the orthogonal transform part 153 orthogonally transforms the direct-current component block generated by the process at step S172, to generate a curved surface parameter block.

At step S174, the curved surface generation part 161 generates an 8×8 curved surface block in which the curved surface parameter block is placed at the upper left end (lower-pass component) and other portions have the value of “0.”

At step S175, the inverse orthogonal transform part 162 subjects the curved surface block generated by the process at step S174 to inverse orthogonal transform, thereby forming a curved surface.

At step S176, the entropy coding part 155 subjects the curved surface parameters generated by the process at step S173 to entropy coding.

Upon completion of the process at step S176, the curved surface predicted image generation part 132 terminates the predicted image generating process, and return to the process shown in FIG. 13 to perform step S153 and the subsequent processes.

As described above, the curved surface predicted image generation part 132 performs curved surface approximation using the original images, which makes it possible to improve prediction accuracy as compared with the case of the conventional intra prediction mode 3 (Plane Prediction mode). Providing this mode as an intra prediction mode allows the image coding device 100 to further improve coding efficiency. The sizes of the foregoing blocks are mere examples as described above with reference to FIG. 9 and others. In addition, in the foregoing description, the curved surface parameters are transferred in combination with header information of coded data. However, the curved surface parameters can be stored in an arbitrary place. For example, the curved surface parameters may be stored in a parameter set of Supplemental Enhancement Information (SEI) (e.g. a header of a sequence or a picture or the like). Alternatively, the curved surface parameters may be transferred separately from the coded data (as a separate file), from an image coding device to an image decoding device.

### 2. Second Embodiment

### [Image Decoding Device]

The coded data coded by the image coding device 100 described in relation to the first embodiment is transferred for decoding to an image decoding device corresponding to the image coding device 100 via a predetermined transmission path.

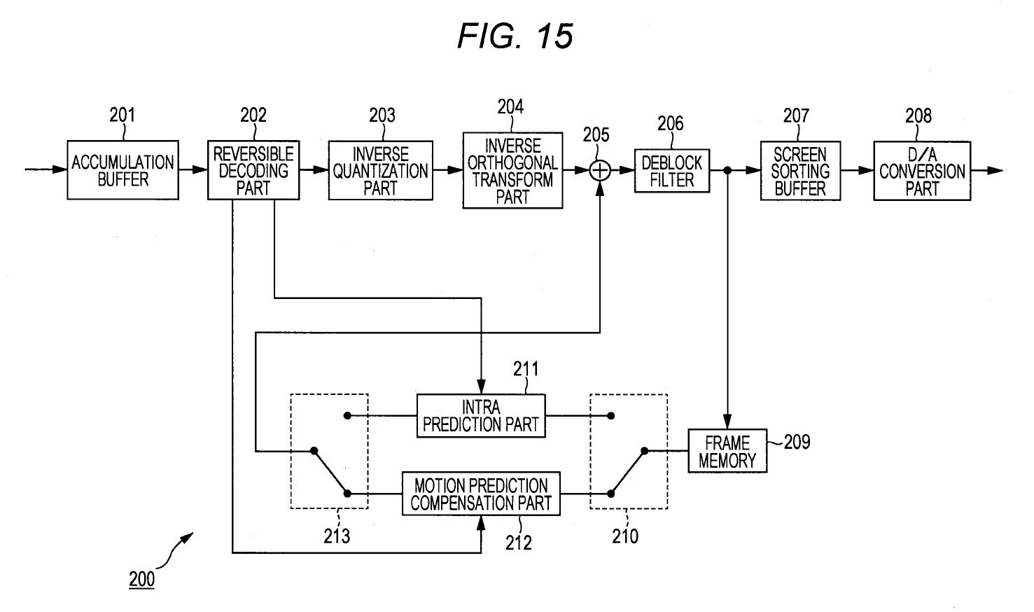

The image decoding device will be described below. FIG. 15 is a block diagram showing a major configuration example of the image decoding device to which the invention is applied.

As shown in FIG. 15, an image decoding device 200 has an accumulation buffer 201; a reversible decoding part 202; an inverse quantization part 203; an inverse orthogonal transform part 204; an arithmetic part 205; a deblock filter 206; a screen sorting buffer 207; a D/A conversion part 208; a frame memory 209; a selection part 210; an intra prediction part 211; a motion prediction compensation part 212; and a selection part 213.

The accumulation buffer 201 accumulates transferred coded data. The coded data is coded by the image coding device 100. The reversible decoding part 202 decodes the coded data read from the accumulation buffer 201 at a predetermined timing, by a scheme corresponding to the coding scheme of the reversible coding part 106 shown in FIG. 1.

The inverse quantization part 203 inversely quantizes the coefficient data obtained through decoding by the reversible decoding part 202, by a scheme corresponding to the quantization scheme of the quantization part 105 shown in FIG. 1. The inverse quantization part 203 supplies the inversely quantized coefficient data to the inverse orthogonal transform part 204. The inverse orthogonal transform part 204 subjects the coefficient data to inverse orthogonal transform by a scheme corresponding to the orthogonal transform scheme of the orthogonal transform part 104 shown in FIG. 1, thereby to obtain decoded residual data corresponding to residual data before orthogonal transform by the image coding device 100.

The decoded residual data obtained through the inverse orthogonal transform is supplied to the arithmetic part 205. In addition, the arithmetic part 205 is also supplied with predicted images from the intra prediction part 211 or the motion prediction compensation part 212, via the selection part 213.

The arithmetic part 205 adds up the decoded residual data and the predicted images, thereby to obtain decoded image data corresponding to the image data before the subtraction of the predicted images by the arithmetic part 103 of the image coding device 100. The arithmetic part 205 supplies the decoded image data to the deblock filter 206.

The deblock filter 206 removes block distortions from the decoded images, and supplies the decoded images to the frame memory 209 for accumulation, and also supplies the decoded images to the screen sorting buffer 207.

The screen sorting buffer 207 sorts the images. Specifically, the frames sorted in the order of coding by the screen sorting buffer 102 shown in FIG. 1 are sorted again in the original order of display. The D/A conversion part 208 subjects the images supplied from the screen sorting buffer 207 to D/A conversion, and outputs the images on a display not shown for indication.

The selection part 210 reads images to be inter-processed and images to be referenced from the frame memory 209, and supplies the images to the motion prediction compensation part 212. The selection part 210 also reads images to be used for intra prediction from the frame memory 209, and supplies the images to the intra prediction part 211.

The intra prediction part 211 is supplied as appropriate with information indicative of an intra prediction mode obtained by decoding header information, information relating to curved surface parameters, and the like, from the reversible decoding part 202. The intra prediction part 211 generates predicted images based on the information, and supplies the generated predicted images to the selection part 213.

The motion prediction compensation part 212 acquires the information obtained by decoding the header information (prediction mode information, motion vector information, and reference frame information) from the reversible decoding part 202. If information indicative of an inter prediction mode is supplied, the motion prediction compensation part 212 generates predicted images based on the inter motion vector information from the reversible decoding part 202, and supplies the generated predicted images to the selection part 213.

The selection part 213 selects the predicted images generated by the motion prediction compensation part 212 or the intra prediction part 211, and supplies the predicted images to the arithmetic part 205.

### [Intra Prediction Part]

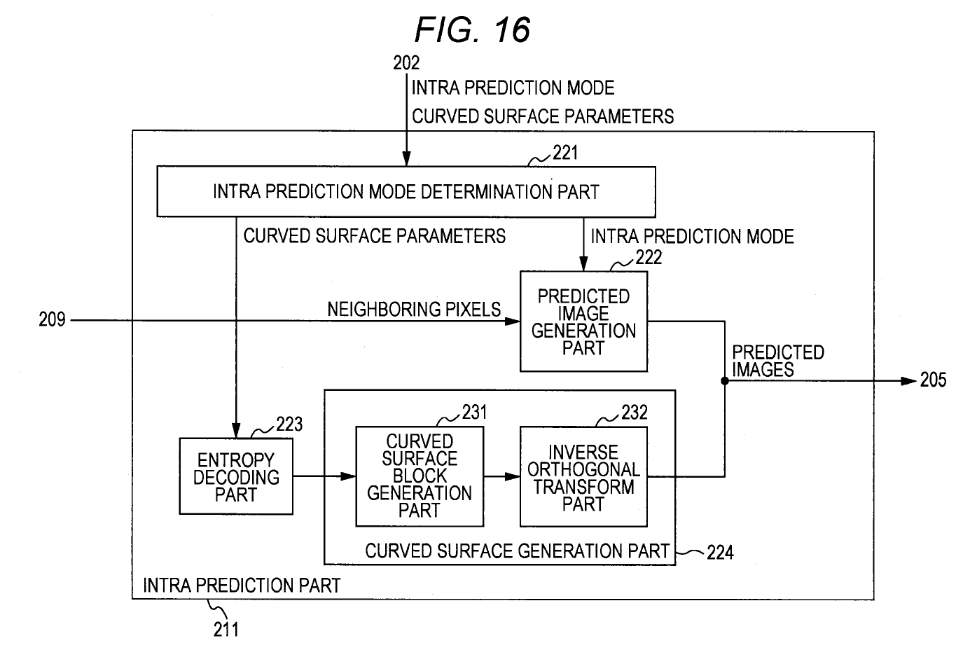

FIG. 16 is a block diagram showing a major configuration example of the intra prediction part 211 shown in FIG. 15.

As shown in FIG. 16, the intra prediction part 211 has an intra prediction mode determination part 221; a predicted image generation part 222; an entropy decoding part 223; and a curved surface generation part 224.

The intra prediction mode determination part 221 determines an intra prediction mode based on information supplied from the reversible decoding part 202. In a mode for generating predicted images using reference images, the intra prediction mode determination part 221 controls the predicted image generation part 222 so as to generate the predicted images. In a mode for generating predicted images from curved surface parameters, the intra prediction mode determination part 221 supplies curved surface parameters supplied together with the intra prediction mode information, to the entropy decoding part 223.

The predicted image generation part 222 acquires reference images of neighboring blocks from the frame memory 209, and uses pixels values of the neighboring pixels to generate predicted images by the same method as the method of the predicted image generation part 131 (FIG. 3) of the image coding device 100. The predicted image generation part 222 supplies the generated predicted images to the arithmetic part 205.

The curved surface parameters supplied to the entropy decoding part 223 via the intra prediction mode determination part 221, has been subjected to entropy coding by the entropy coding part 155 (FIG. 8). The entropy decoding part 223 subjects the curved surface parameters to entropy decoding by the method corresponding to the entropy coding method. The entropy decoding part 223 supplies the decoded curved surface parameters to the curved surface generation part 224.

The curved surface generation part 224 generates an approximate curved surface (predicted images) based on the curved surface parameters, in the same manner as with the curved surface generation part 154 (FIG. 8) of the image coding device 100. The curved surface generation part 224 has a curved surface block generation part 231 and an inverse orthogonal transform part 232.

The curved surface block generation part 231 generates a curved surface block in which a block of the curved surface parameters is a lower-pass component (a coefficient at an upper left end) and the other portions have the coefficient value of “0,” in the same manner as with the curved surface block generation part 161 (FIG. 8). That is, a block similar to the curved surface block 177 shown in FIG. 9E, is generated.

The inverse orthogonal transform part 232 subjects the 8×8 curved surface block generated by the curved surface block generation part 231 to inverse orthogonal transform. That is, a curved surface (approximate curved surface) similar to the curved surface 178 shown in FIG. 9F, is generated.

The inverse orthogonal transform part 232 supplies the generated approximate curved surface as predicted images to the arithmetic part 205.

### [Decoding Process]

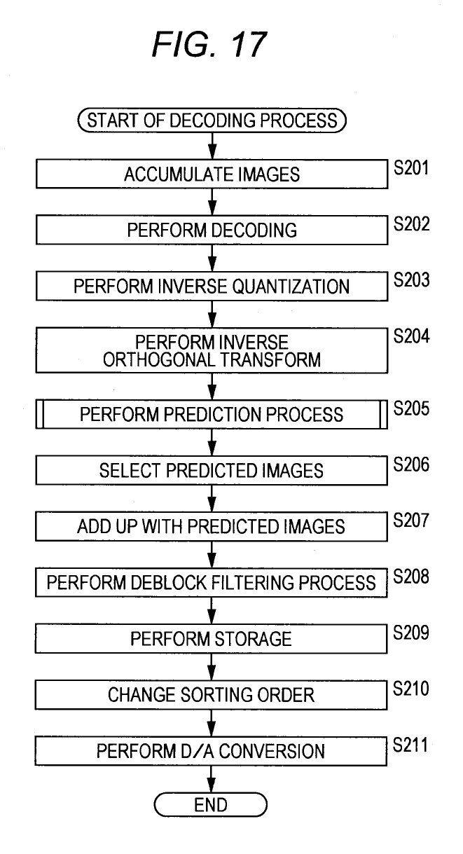

Next, flows of processes performed by the image decoding device 200 will be described. First, an example of a flow of a decoding process will be described with reference to a flowchart shown in FIG. 17.

When the decoding process is started, at step S201, the accumulation buffer 201 accumulates transferred coded data. At step S202, the reversible decoding part 202 decodes the coded data supplied from the accumulation buffer 201. That is, the I picture, the P picture, and the B picture coded by the reversible coding part 106 shown in FIG. 1 are decoded.

At that time, motion vector information, reference frame information, prediction mode information (intra prediction mode or inter prediction mode), flag information, curved surface parameters, and the like, are also decoded.

Specifically, if the prediction mode information is intra prediction mode information, the prediction mode information is supplied to the intra prediction part 211. If the prediction mode information is inter prediction mode information, motion vector information corresponding to the prediction mode information is supplied to the motion prediction compensation part 212.

In addition, if there exist curved surface parameters, the curved surface parameters are supplied to the intra prediction part 211.

At step S203, the inverse quantization part 203 inversely quantizes the conversion coefficient decoded by the reversible decoding part 202, using characteristics corresponding to the characteristics of the quantization part 105 shown in FIG. 1. At step S204, the inverse orthogonal transform part 204 subjects the conversion coefficient inversely quantized by the inverse quantization part 203, to inverse orthogonal transform, using characteristics corresponding to the characteristics of the orthogonal transform part 104 shown in FIG. 1. Accordingly, different information corresponding to input into the orthogonal transform part 104 shown in FIG. 1 (output from the arithmetic part 103) is decoded.

At step S205, the intra prediction part 211 or the motion prediction compensation part 212 performs an image prediction process, in correspondence with predicted mode information supplied from the reversible decoding part 202.

Specifically, if intra prediction mode information is supplied from the reversible decoding part 202, the intra prediction part 211 performs an intra prediction process in the intra prediction mode. In addition, if curved surface parameters are also supplied from the reversible decoding part 202, the intra prediction part 211 performs an intra prediction process using the curved surface parameters.

If inter prediction mode information is supplied from the reversible decoding part 202, the motion prediction compensation part 212 performs a motion prediction process in the inter prediction mode.

At step S206, the selection part 213 selects predicted images. Specifically, the selection part 213 is supplied with predicted image generated by the intra prediction part 211 or predicted images generated by the motion prediction compensation part 212. The selection part 213 selects either of the predicted images. The selected predicted images are supplied to the arithmetic part 205.

At step S207, the arithmetic part 205 adds the predicted images selected by the process at step S206 to the residual information obtained by the process at step S204. Accordingly, the original image data is decoded.

At step S208, the deblock filter 206 filters the decoded image data supplied from the arithmetic part 205. Accordingly, block distortions are removed.

At step S209, the frame memory 209 stores the filtered decoded image data.

At step S210, the screen sorting buffer 207 changes the sorting of frames of the decoded image data. Specifically, the frames sorted in the order of coding by the screen sorting buffer 102 (FIG. 1) of the image coding device 100, are sorted again in the original order of display.

At step S211, the D/A conversion part 208 subjects the decoded image data with the frames sorted by the screen sorting buffer 207, to D/A conversion. The decoded image data is output to a display not shown for indication.

### [Prediction Process]

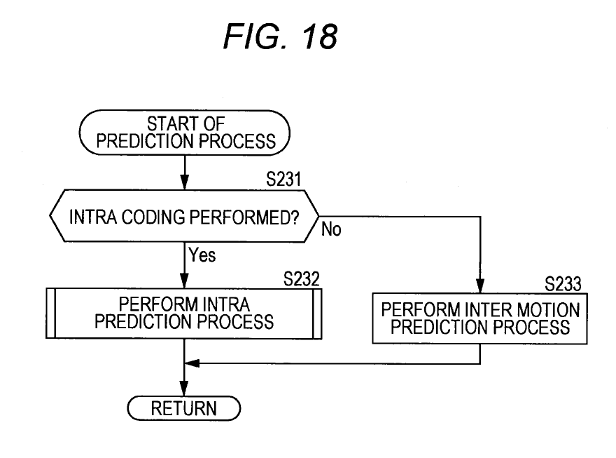

Next, an example of a flow of a prediction process performed at step S205 shown in FIG. 17 will be described with reference to a flowchart shown in FIG. 18.

When the prediction process is started, the reversible decoding part 202 determines whether intra coding is performed based on intra prediction mode information or not. If determining that intra coding is performed, the reversible decoding part 202 supplies the intra prediction mode information to the intra prediction part 211 and moves the process to step S232. If there exist curved surface parameters, the reversible decoding part 202 also supplies the curved surface parameters to the intra prediction part 211.

At step S232, the intra prediction part 211 performs an intra prediction process. Upon completion of the intra prediction process, the image decoding device 200 returns to the process shown in FIG. 17 to perform step S206 and the subsequent processes.

In addition, if determining at step S231 that inter coding is performed, the reversible decoding part 202 supplies inter prediction mode information to the motion prediction compensation part 212, and moves the process to step S233.

At step S233, the motion prediction compensation part 212 performs an inter motion prediction compensation process. Upon completion of the inter motion prediction compensation process, the image decoding device 200 returns to the process shown in FIG. 17 to perform step S206 and the subsequent processes.

### [Intra Prediction Process]

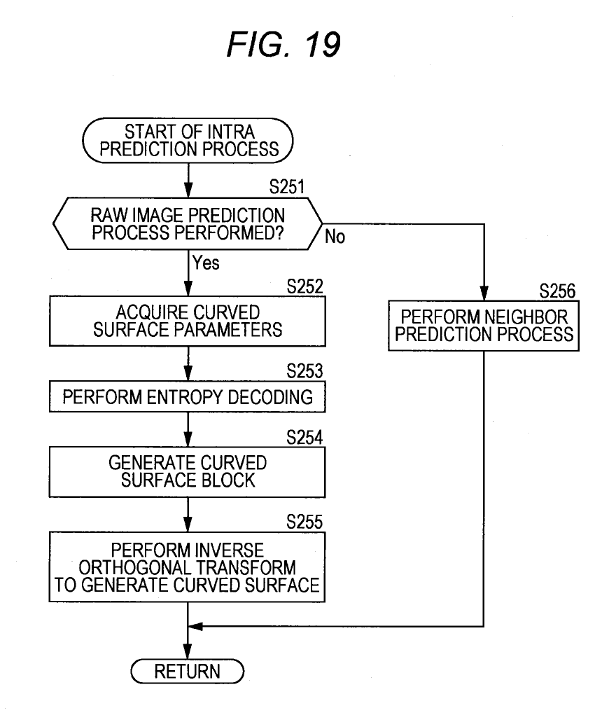

Next, an example of a flow of an intra prediction process performed at step S232 shown in FIG. 18 will be described with reference to a flowchart shown in FIG. 19.

When the intra prediction process is started, the intra prediction mode determination part 221 determines at step S251 whether a raw image prediction process for performing a prediction process using curved surface parameters generated from original images (raw images) supplied from the image coding device 100, is performed or not. If determining that a raw image prediction process is performed based on intra prediction mode information supplied from the reversible decoding part 202, the intra prediction mode determination part 221 moves the process to step S252.

At step S252, the intra prediction mode determination part 221 acquires curved surface parameters from the reversible decoding part 202.

At step S253, the entropy decoding part 223 subjects the curved surface parameters to entropy decoding.

At step S254, the curved surface block generation part 231 generates an 8×8 curved surface block in which the entropy-decoded curved surface parameter block (2×2) is placed at the upper left end (lower-pass component) and other portions have the value of “0.”

At step S255, the inverse orthogonal transform part 232 subjects the generated curved surface block to inverse orthogonal transform, thereby generating a curved surface. The curved surface is supplied as predicted images to the arithmetic part 205.

Upon completion of the process at step S255, the intra prediction part 211 returns to the processes shown in FIG. 18 and terminates the prediction process. The image decoding device 200 returns to the process shown in FIG. 17 to perform step S206 and the subsequent processes.

In addition, if determining at step S251 that no raw image prediction process is performed, the intra prediction mode determination part 221 moves the process to step S256.

At step S256, the predicted image generation part 222 acquires reference images from the frame memory 209, and performs a neighborhood prediction process for predicting a process target block from neighboring pixels contained in the reference images. Upon completion of the process at step S256, the intra prediction part 211 returns to the processes shown in FIG. 18 and terminates the prediction process. The image decoding device 200 returns to the process shown in FIG. 17 to perform step S206 and the subsequent processes.

As described in the foregoing, the intra prediction part 211 generates predicted images using curved surface parameters supplied from the image coding device 100, and therefore the image decoding device 200 can decode data coded in the intra prediction mode by the image coding device 100 using the original images. That is, the image decoding device 200 can decode data coded in the intra prediction mode with high prediction accuracy.

In addition, the entropy decoding part 223 can decode entropy-coded curved surface parameters. That is, the image decoding device 200 can perform a decoding process using curved surface parameters with reduced data amount.

That is, the image decoding device 200 can further improve coding efficiency.

Alternatively, Hadamard transform or the like may be used instead of the orthogonal transform or inverse orthogonal transform described above. In addition, the sizes of the blocks described above are mere examples.

### [Macro Blocks]

As in the foregoing description, the sizes of the macro blocks are 16×16 or less. Alternatively, the sizes of the macro blocks may be larger than 16×16.

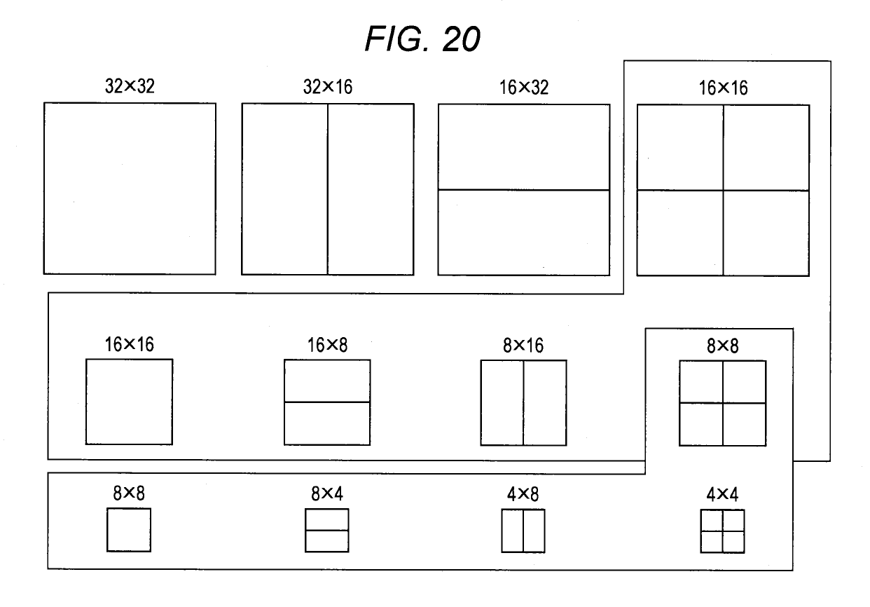

The invention can be applied to macro blocks of all sizes as shown in FIG. 20, for example. For instance, the invention can be applied to not only general macro blocks of 16×16 pixels but also macro blocks extended to 32×32 pixels (extended macro blocks).

FIG. 20 shows macro blocks of 32×32 pixels divided to blocks (partitions) of 32×32 pixels, of 32×16 pixels, 16×32 pixels, and 16×16 pixels, starting from the left at the upper part. FIG. 20 also shows blocks of 16×16 pixels divided to blocks of 16×16 pixels, 16×8 pixels, 8×16 pixels, and 8×8 pixels, starting from the left at the middle part. FIG. 20 further shows blocks of 8×8 pixels divided to blocks of 8×8 pixels, 8×4 pixels, 4×8 pixels, and 4×4 pixels, starting from the left at the lower part in this order.

That is, the macro block of 32×32 pixels can be processed by the blocks of 32×32 pixels, 32×16 pixels, 16×32 pixels, and 16×16 pixels shown at the upper part.

The blocks of 16×16 pixels shown on the right of the upper part can be processed by blocks of 16×16 pixels, 16×8 pixels, 8×16 pixels, and 8×8 pixels shown at the middle part, in the same manner as the H.264/AVC scheme.

The block of 8×8 pixels shown on the right of the middle part can be processed by blocks of 8×8 pixels, 8×4 pixels, 4×8 pixels, and 4×4 pixels shown at the lower part, in the same manner as the H.264/AVC scheme.

These blocks can be classified into the following three hierarchies. Specifically, the blocks of 32×32 pixels, 32×16 pixels, and 16×32 pixels shown on the upper part of FIG. 20 are designated as a first hierarchy. The block of 16×16 pixels shown on the right of the upper part and the blocks of 16×16 pixels, 16×8 pixels, and 8×16 pixels shown on the middle part are designated as a second hierarchy. The blocks of 8×8 pixels shown on the right of the middle part and the blocks of 8×8 pixels, 8×4 pixels, 4×8 pixels, and 4×4 pixels shown on the lower part are designated as a third hierarchy.

By employing the thus hierarchical structure, larger blocks with respect to blocks of 16×16 pixels or less can be defined as super sets of the blocks while maintaining compatibility with the H.264/AVC scheme.

### 3. Third Embodiment

### [Personal Computer]

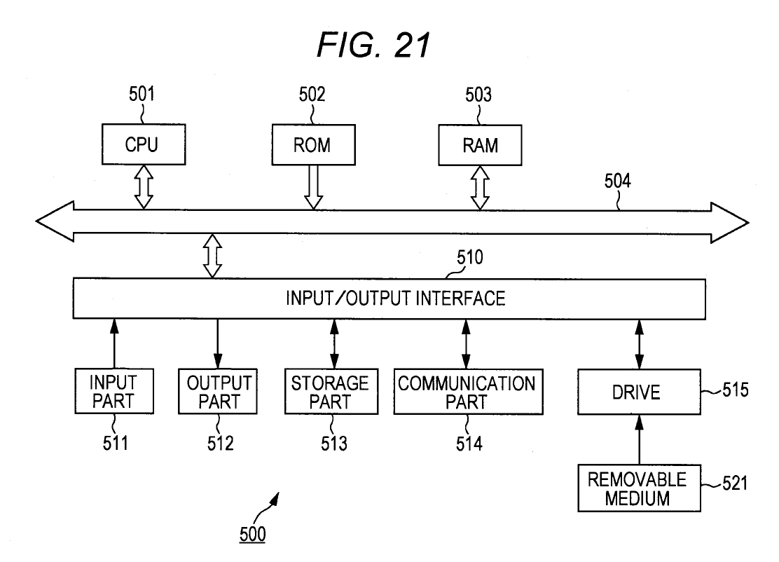

The foregoing series of processes may be performed by hardware or software. In this case, the hardware or software may be configured as a personal computer shown in FIG. 21, for example

In FIG. 21, a personal computer 500 has a CPU 501 that performs various processes according to programs stored in a read only memory (ROM) 502 or programs loaded from a storage part 513 into a random access memory (RAM) 503. The RAM 503 also stores as appropriate data needed for the CPU 501 to perform various processes and the like.

The CPU 501, the ROM 502, and the RAM 503, are connected to each other via a bus 504. The bus 504 also connects to an input/output interface 510.

The input/output interface 510 are connected to an input part 511 formed by a keyboard, a mouse, and the like; an output part 512 formed by a display including a cathode ray tube (CRT), and a liquid crystal display (LCD), and a speaker and the like; a storage part 513 formed by a hard disc and the like; and a communication part 514 formed by a modem and the like. The communication part 514 performs a communication process via a network including the Internet.

The input/output interface 510 is also connected as necessary to a drive 515, and is attached as appropriate to a removable medium 521 such as a magnetic disc, an optical disc, a magnet-optical disc, or a semiconductor memory. Computer programs read from these media are installed as necessary into the storage part 513.

If the foregoing series of processes are to be executed by software, a program constituting the software is installed from a network or a recording medium.

As shown in FIG. 21, for example, the recording medium may be formed not only by the program-recorded removable medium 521 including a magnetic disc (including a flexible disc), an optical disc (including a compact disc-read only memory (CD-ROM) and a digital versatile disc (DVD)), a magnet-optical disc (MD (including a mini disc), or a semiconductor memory, which are delivered separately from the device body to users for distribution of the programs, but also by the program-recorded ROM 502, a hard disc included in the storage part 513, or the like, which are delivered to users in a state of being incorporated in advance into the device body.

The programs to be executed by the computer may be executed chronologically in the order of description herein or may be executed in parallel or at a required timing when any of the programs is invoked or the like.

The steps for describing a program to be recorded in a recording medium listed herein, include not only processes to be performed chronologically in the order of description herein but also processes to be performed in parallel or individually even if the processes are not always performed chronologically.

The system herein refers to the entire apparatus formed by a plurality of devices (units).

In the foregoing description, a configuration of one device (or one processing part) may be formed by a plurality of devices (or processing parts). In contrast, a configuration of a plurality of devices (or processing parts) may be collectively formed by one device (or one processing part). As a matter of course, any configuration other than the foregoing configurations may be added to the foregoing devices (or processing parts). Further, a part of a configuration of a device (or a processing part) may be included in a configuration of another device (or another processing part) if the configuration and motion are substantially the same as that of the device described above as the whole system. That is, embodiments of the invention are not limited to the foregoing embodiments but may be modified in various manners without departing from the gist of the invention.

For example, the image coding device 100 and the image decoding device 200 can be applied to any electronic device. Some application examples will be described below.

### 4. Fourth Embodiment

### [Television Receiver]

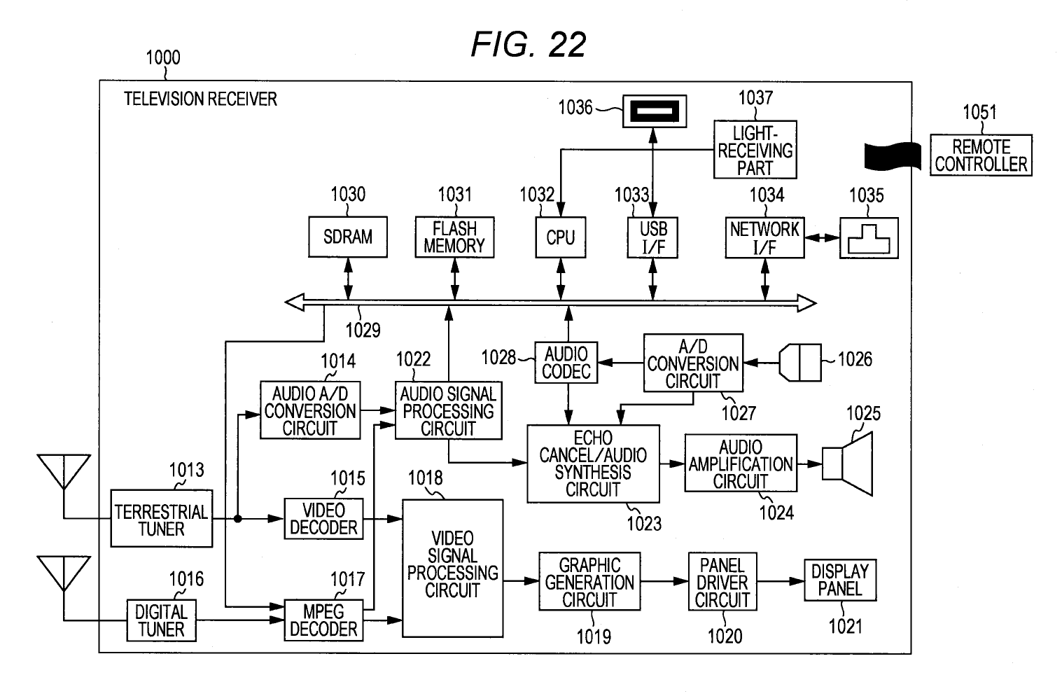

FIG. 22 is a block diagram showing a major configuration example of a television receiver using the image decoding device 200 to which the invention is applied.

A television receiver 1000 shown in FIG. 22 has a terrestrial tuner 1013; a video decoder 1015; a video signal processing circuit 1018; a graphic generation circuit 1019; a panel drive circuit 1020; and a display panel 1021.

The terrestrial tuner 1013 receives a broadcast wave signal for analog terrestrial broadcast via an antenna, demodulates the signal to acquire a video signal, and supplies the signal to the video decoder 1015. The video decoder 1015 performs a decode process on the video signal supplied from the terrestrial tuner 1013, and supplies an obtained digital component signal to the video signal processing circuit 1018.

The video signal processing circuit 1018 performs a predetermined process such as denoising on the video data supplied from the video decoder 1015, and supplies obtained video data to the graphic generation circuit 1019.

The graphic generation circuit 1019 generates video data for a television program to be displayed on the display panel 1021, image data resulting from a process based on an application supplied via a network, and the like, and supplies the generated video data and image data to the panel drive circuit 1020. The graphic generation circuit 1019 also as appropriate generates video data (graphics) for display of screens to be used by a user for selection of an item, superimposes the data on the video data for a television program, and supplies video data obtained by the superimposition to the panel drive circuit 1020.

The panel drive circuit 1020 drives the display panel 1021 based on the data supplied from the graphic generation circuit 1019, and displays video images for a television program and the foregoing various screens on the display panel 1021.

The display panel 1021 is formed by a liquid crystal display (LCD) and the like, and displays video images for a television program and the like, under control of the panel drive circuit 1020.

In addition, the television receiver 1000 has also an audio analog/digital (A/D) conversion circuit 1014; an audio signal processing circuit 1022; an echo cancel/audio synthesis circuit 1023; an audio amplification circuit 1024; and a speaker 1025.

The terrestrial tuner 1013 demodulates a received broadcast wave signal to acquire not only a video signal but also an audio signal. The terrestrial tuner 1013 supplies the acquired audio signal to the audio A/D conversion circuit 1014.

The audio A/D conversion circuit 1014 performs an A/D conversion process on the audio signal supplied from the terrestrial tuner 1013, and supplies an obtained digital audio signal to the audio signal processing circuit 1022.

The audio signal processing circuit 1022 performs a predetermined process such as denoising on the audio data supplied from the audio A/D conversion circuit 1014, and supplies the obtained audio data to the echo cancel/audio synthesis circuit 1023.

The echo cancel/audio synthesis circuit 1023 supplies the audio data supplied from the audio signal processing circuit 1022 to the audio amplification circuit 1024.

The audio amplification circuit 1024 performs a D/A conversion process and an amplification process on the audio data supplied from the echo cancel/audio synthesis circuit 1023 to adjust the audio data at a predetermined sound volume, and then outputs sounds through the speaker 1025.

Further, the television receiver 1000 also has a digital tuner 1016 and an MPEG decoder 1017.

The digital tuner 1016 receives a broadcast wave signal for digital broadcast (digital terrestrial broadcast, broadcasting satellite (BS)/communications satellite (CS) digital broadcast) via an antenna, demodulates the signal to acquire a moving picture experts group-transport stream (MPEG-TS), and supplies it to the MPEG decoder 1017.

The MPEG decoder 1017 descrambles the MPEG-TS supplied from the digital tuner 1016 and extracts a stream containing data for a television program to be reproduced (to be viewed). The MPEG decoder 1017 decodes audio packets constituting the extracted stream and supplies obtained audio data to the audio signal processing circuit 1022, and decodes video packets constituting the stream and supplies obtained video data to the video signal processing circuit 1018. In addition, the MPEG decoder 1017 supplies electronic program guide (EPG) data extracted from the MPEG-TS to the CPU 1032 via a path not shown.

The television receiver 1000 uses the image decoding device 200 as MPEG decoder 1017 decoding video packets as described above. The MPEG-TS transmitted from a broadcast station and the like has been coded by the image coding device 100.

The MPEG decoder 1017 generates predicted images using curved surface parameters extracted from coded data supplied from the image coding device 100, and generates decoded image data from residual information using the predicted images, as in the case of the image decoding device 200. Therefore, the MPEG decoder 1017 can further improve coding efficiency.

The video data supplied from the MPEG decoder 1017 is subjected to a predetermined process at the video signal processing circuit 1018, and generated video data and the like are superimposed as appropriate at the graphic generation circuit 1019, and are supplied to the display panel 1021 via the panel drive circuit 1020 for image display, as in the case of the video data supplied from the video decoder 1015.

The audio data supplied from the MPEG decoder 1017 is subjected to a predetermined process at the audio signal processing circuit 1022, supplied to the audio amplification circuit 1024 via the echo cancel/audio synthesis circuit 1023, and subjected to a D/A conversion process and an amplification process, as in the case of the audio data supplied from the audio A/D conversion circuit 1014. As a result, sounds adjusted to a predetermined sound volume are output through the speaker 1025.

In addition, the television receiver 1000 also has a microphone 1026 and an A/D conversion circuit 1027.

The A/D conversion circuit 1027 receives an audio signal of a user for audio communication captured by the microphone 1026 in the television receiver 1000, and performs an A/D conversion process on the received audio signal, and supplies obtained digital audio data to the echo cancel/audio synthesis circuit 1023.

If audio data of a user (user A) of the television receiver 1000 is supplied from the A/D conversion circuit 1027, the echo cancel/audio synthesis circuit 1023 performs echo cancellation on the audio data of user A, combines the audio data with other audio data, and outputs obtained audio data through the speaker 1025 via the audio amplification circuit 1024.

Further, the television receiver 1000 also has an audio codec 1028; an internal bus 1029; a synchronous dynamic random access memory (SDRAM) 1030; a flash memory 1031; a CPU 1032; a universal serial bus (USB) I/F 1033; and a network I/F 1034.

The A/D conversion circuit 1027 receives an audio signal of a user's voice for audio communication captured by the microphone 1026 in the television receiver 1000, and performs an A/D conversion process on the received audio signal, and supplies obtained digital audio data to the audio codec 1028.

The audio codec 1028 converts the audio data supplied from the A/D conversion circuit 1027 to data in a predetermined format for transmission over a network, and supplies the data to the network I/F 1034 via the internal bus 1029.

The network I/F 1034 is connected to a network via a cable attached to a network terminal 1035. The network I/F 1034 transmits audio data supplied from the audio codec 1028 to another device connected to the network, for example. In addition, the network I/F 1034 receives via the network terminal 1035 audio data transmitted from another device connected via a network, and supplies the same to the audio codec 1028 via the internal bus 1029.

The audio codec 1028 converts the audio data supplied from the network I/F 1034 to data in a predetermined format, and supplies the data to the echo cancel/audio synthesis circuit 1023.

The echo cancel/audio synthesis circuit 1023 performs echo cancellation on the audio data supplied from the audio codec 1028, combines the audio data with other audio data, and outputs obtained audio data through the speaker 1025 via the audio amplification circuit 1024.

The SDRAM 1030 stores various kinds of data needed for the CPU 1032 to perform processes.

The flash memory 1031 stores programs to be executed by the CPU 1032. The programs stored in the flash memory 1031 are read by the CPU 1032 at a predetermined timing when the television receiver 1000 is started or the like. The flash memory 1031 also stores EPG data acquired via digital broadcast, data acquired from a predetermined server via a network, and the like.

For example, the flash memory 1031 stores an MPEG-TS containing contents data acquired from a predetermined server via a network under control of the CPU 1032. The flash memory 1031 supplies the MPEG-TS to the MPEG decoder 1017 via the internal bus 1029 under control of the CPU 1032, for example.

The MPEG decoder 1017 processes the MPEG-TS in the same manner as the MPEG-TS supplied from the digital tuner 1016. Accordingly, the television receiver 1000 can receive contents data formed by video images, sounds, and the like, via a network, decode the data using the MPEG decoder 1017, and display the video images and output the sounds.

In addition, the television receiver 1000 also has a light-receiving part 1037 receiving an infrared signal transmitted from a remote controller 1051.

The light-receiving part 1037 receives infrared rays from the remote controller 1051, demodulates the infrared rays, and outputs an obtained control code indicative of contents of a user operation, to the CPU 1032.

The CPU 1032 executes programs stored in the flash memory 1031 and controls an entire operation of the television receiver 1000 according to a control code or the like supplied from the light-receiving part 1037. The CPU 1032 and the components of the television receiver 1000 are connected together via a path not shown.

The USB I/F 1033 transmits/receives data with devices outside of the television receiver 1000, which is connected via a USB cable attached to a USB terminal 1036. The network I/F 1034 connects to a network via a cable attached to the network terminal 1035 to transmit/receive data other than audio data, with various devices connected to the network.

The television receiver 1000 can further improve coding efficiency using the image decoding device 200 as MPEG decoder 1017. Consequently, the television receiver 1000 can further improve efficiency of coding a broadcast wave signal received via an antenna and contents data acquired via a network, thereby realizing real-time processes at lower costs.

### 5. Fifth Embodiment

### [Cellular Phone]

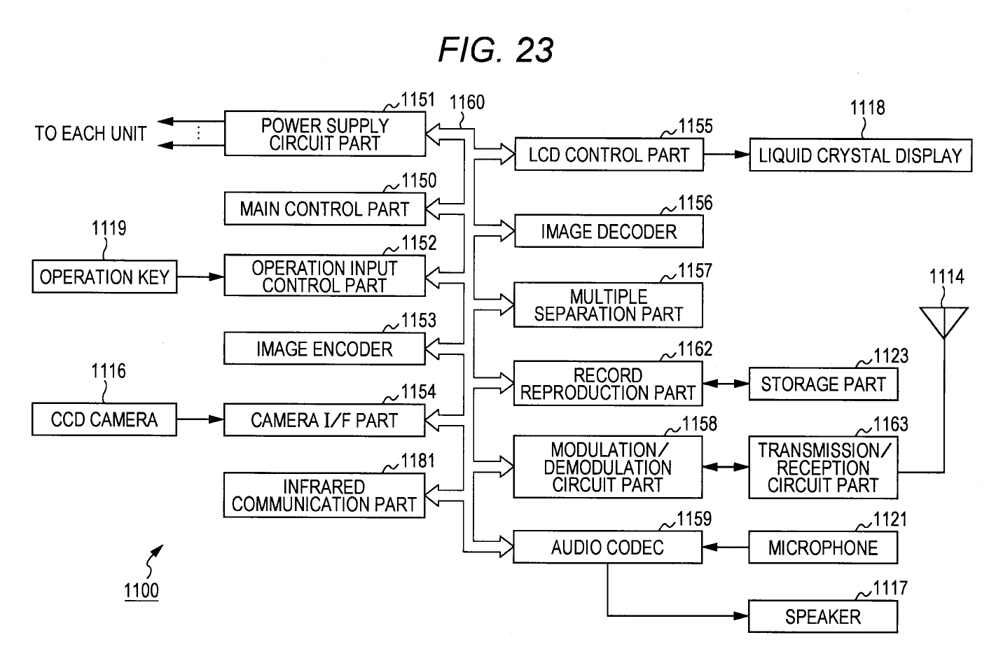

FIG. 23 is a block diagram showing a major configuration example of a cellular phone using the image coding device 100 and the image decoding device 200 to which the invention is applied.

A cellular phone 1100 shown in FIG. 23 has a main control part 1150 configured to control all components comprehensively; a power supply circuit part 1151; an operation input control part 1152; an image encoder 1153; a camera I/F part 1154; an LCD control part 1155; an image decoder 1156; a multiple separation part 1157; a record reproduction part 1162; a modulation/demodulation circuit part 1158; and an audio codec 1159. These components are connected to each other via a bus 1160.

The cellular phone 1100 also has an operation key 1119; a charge coupled devices (CCD) camera 1116; a liquid crystal display 1118; a storage part 1123; a transmission/reception circuit part 1163; an antenna 1114; a microphone 1121; and a speaker 1117.

When a call-ending and power key is turned on by a user, the power supply circuit part 1151 supplies power from a battery pack to the components, thereby entering the cellular phone 1100 into an operable state.

The cellular phone 1100 performs various operations, such as transmission/reception of audio signals, transmission/reception of e-mails and image data, image shooting, or data recording, in various modes such as an audio communication mode and a data communication mode, under control of the main control part 1150 formed by a CPU, a ROM, a RAM, and the like.

In the audio communication mode, for example, the cellular phone 1100 converts an audio signal of sounds collected by the microphone 1121 to digital audio data by the use of the audio codec 1159, and performs a spread spectrum process on the signals at the modulation/demodulation circuit part 1158, and then performs a digital-analog conversion process and a frequency conversion process on the signals at the transmission/reception circuit part 1163. The cellular phone 1100 transmits a transmission signal obtained by the foregoing conversion processes to a base station not shown via the antenna 1114. The transmission signal (audio signal) transferred to the base station is supplied to a cellular phone of the other end of communication via a public telephone line network.

In addition, in the audio communication mode, for example, the cellular phone 1100 amplifies the received signal by the antenna 1114 at the transmission/reception circuit part 1163, performs a frequency conversion process and an analog-digital conversion process on the signal, performs an inverse spread spectrum process on the signal at the modulation/demodulation circuit part 1158, and converts the signal to an analog audio signal by the audio codec 1159. The cellular phone 1100 outputs the analog audio signal obtained by the foregoing conversion processes, through the speaker 1117.

Further, if an e-mail is to be transmitted in the data communication mode, for example, the cellular phone 1100 accepts text data of the e-mail input through the operation of the operation key 1119, at the operation input control part 1152. The cellular phone 1100 processes the text data at the main control part 1150, and displays the text data as an image on the liquid crystal display 1118 via the LCD control part 1155.

The cellular phone 1100 also generates e-mail data at the main control part 1150, based on text data accepted by the operation input control part 1152 and according to a user's instruction and the like. The cellular phone 1100 performs a spread spectrum process on the e-mail data at the modulation/demodulation circuit part 1158 and performs a digital-analog conversion process and a frequency conversion process on the e-mail data at the transmission/reception circuit part 1163. The cellular phone 1100 transmits a transmission signal obtained by the foregoing conversion processes, to a base station not shown via the antenna 1114. The transmission signal (e-mail) transferred to the base station is supplied to a prescribed destination via a network, a mail server, and the like.

In addition, if an e-mail is to be received in the data communication mode, for example, the cellular phone 1100 receives a signal transmitted from a base station at the transmission/reception circuit part 1163 via the antenna 1114, amplifies the signal, and then performs a frequency conversion process and an analog-digital conversion process on the signal. The cellular phone 1100 performs an inverse spread spectrum process on the received signal at the modulation/demodulation circuit part 1158, thereby to restore the original e-mail data. The cellular phone 1100 displays the restored e-mail data on the liquid crystal display 1118 via the LCD control part 1155.

The cellular phone 1100 may also record (store) the received e-mail data in the storage part 1123 via the selection part 1162.

The storage part 1123 is an arbitrary rewritable storage medium. The storage part 1123 may be a semiconductor memory such as a RAM or a built-in flash memory, hard disc, or a removable medium such as a magnetic disc, a magnet-optical disc, an optical disc, a USB memory, or a memory card, for example. As a matter of course, the storage part 1123 may be any other medium.

Further, if image data is to be transmitted in the data communication mode, for example, the cellular phone 1100 generates image data by image shooting with the CCD camera 1116. The CCD camera 1116 has optical devices such as a lens and a diaphragm, and a CCD as a photoelectric conversion element. The CCD camera 1116 shoots a subject, and converts strength of received light into an electrical signal to generate image data for an image of the subject. The CCD camera 1116 encodes the image data at the image encoder 1153 via the camera I/F part 1154, thereby converting the image data to coded image data.

The cellular phone 1100 uses the image coding device 100 described above as the image encoder 1153 performing the foregoing process. The image encoder 1053 performs curved surface approximation by using pixel values of process target blocks of the original images, thereby generating a predicted image, as in the case of the image coding device 100. The image encoder 1053 can further improve coding efficiency by coding the image data using the predicted image.

At the same time, the cellular phone 1100 subjects sounds collected by the microphone 1121 during image shooting by the CCD camera 1116, to analog-digital conversion for further coding at the audio codec 1159.

The cellular phone 1100 multiplexes the coded image data supplied from the image encoder 1153 and the digital audio data supplied from the audio codec 1159, by a predetermined scheme, at the multiple separation part 1157. The cellular phone 1100 performs a spread spectrum process on resulting multiplexed data at the modulation/demodulation circuit part 1158, and performs a digital-analog conversion process and a frequency conversion process on the multiplexed data at the transmission/reception circuit part 1163. The cellular phone 1100 transmits a transmission signal obtained by the foregoing conversion processes to a base station not shown via the antenna 1114. The transmission signal (image data) transferred to the base station is supplied to the other end of communication via a network and the like.

If the image data is not to be transmitted, the cellular phone 1100 may also display the image data generated by the CCD camera 1116, on the liquid crystal display 1118 via the LCD control part 1155, not via the image encoder 1153.

In addition, in the data communication mode, for example, if data of a moving image file linked to a simplified homepage or the like is to be received, the cellular phone 1100 receives a signal transmitted from a base station at the transmission/reception circuit part 1163 via the antenna 1114, amplifies the signal, and performs a frequency conversion process and an analog-digital conversion process on the signal. The cellular phone 1100 performs an inverse spread spectrum process on the received signal at the modulation/demodulation circuit part 1158, thereby to restore the original multiplexed data. The cellular phone 1100 divides the multiplexed data into coded image data and audio data at the multiple separation part 1157.

The cellular phone 1100 generates reproduction moving image data by decoding the coded image data at the image decoder 1156, and displays the data on the liquid crystal display 1118 via the LCD control part 1155. Accordingly, the moving image data included in the moving image file linked to a simplified homepage, for example, is displayed on the liquid crystal display 1118.

The cellular phone 1100 uses the image decoding device 200 described above as image decoder 1156 performing the foregoing process. That is, the image decoder 1156 generates predicted images using curved surface parameters extracted from coded data supplied from the image coding device 100, and generates decoded image data from residual information using the predicted images, as in the case of the image decoding device 200. Therefore, the image decoder 1156 can further improve coding efficiency.

At the same time, the cellular phone 1100 converts the digital audio data to an analog audio signal at the audio codec 1159, and outputs the data from the speaker 1117. Accordingly, audio data included in a moving image file linked to a simplified homepage, for example, is reproduced.

In addition, as in the case of an e-mail, the cellular phone 1100 can also record (store) the received data linked to a simplified homepage or the like, in the storage part 1123 via the record reproduction part 1162.

The cellular phone 1100 can also analyze a two-dimensional code obtained by image shooting with the CCD camera 1116, at the main control part 1150, and acquire information recorded in the two-dimensional code.

Further, the cellular phone 1100 can communicate with external devices by infrared rays at the infrared communication part 1181.

The cellular phone 1100 can use the image coding device 100 as the image encoder 1153 to further improve coding efficiency on coding and transferring image data generated at the CCD camera 1116, for example, thereby realizing real-time processes at lower costs.

The cellular phone 1100 can use the image decoding device 200 as the image decoder 1156 to further improve efficiency of coding data in a moving image file (coded data) linked to a simplified homepage or the like, for example, thereby realizing real-time processes at lower costs.

As in the foregoing description, the cellular phone 1100 uses the CCD camera 1116. Alternatively, the cellular phone 1100 may use an image sensor using complementary metal oxide semiconductor (CMOS) (CMOS image sensor) in place of the CCD camera 1116. In this case, the cellular phone 1100 can shoot a subject and generate image data for an image of the subject, as in the case of using the CCD camera 1116.

In addition, the cellular phone 1100 is exemplified in the foregoing description. However, the image coding device 100 and the image decoding device 200 can also be applied to other devices as in the case of the cellular phone 1100, such as personal digital assistants (PDAs), smart phones, ultra mobile personal computers (UMPCs), netbooks, and notebook personal computers, for example, as far as the devices have the same shooting and communication capabilities as those of the cellular phone 1100.

### 6. Sixth Embodiment

### [Hard Disc Recorder]

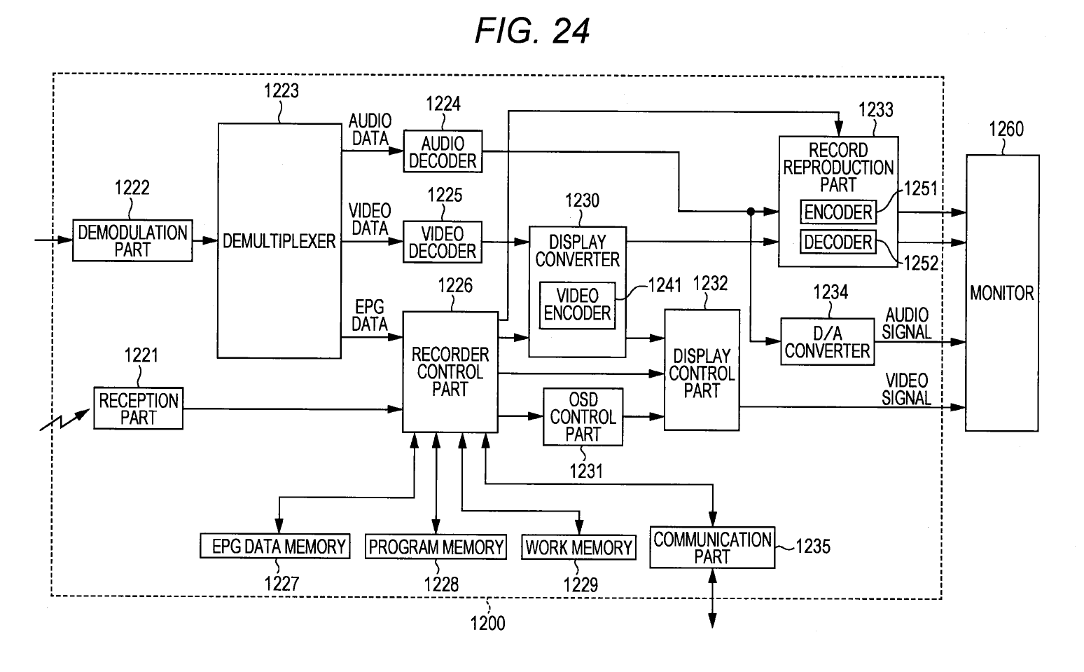

FIG. 24 is a block diagram showing a major configuration example of a hard disc recorder using the image coding device 100 and the image decoding device 200 to which the invention is applied.

The hard disc recorder (HDD recorder) 1200 shown in FIG. 24 stores audio data and video data for broadcast programs included in broadcast wave signals (television signals) transmitted from a satellite or a terrestrial antenna or the like and received by a tuner, in a built-in hard disc, and provides the stored data to a user at a timing specified by the user's instruction.

The hard disc recorder 1200 can extract audio data and video data from broadcast wave signals, decode the data as appropriate, and store the data in a built-in hard disc, for example. In addition, the hard disc recorder 1200 can also acquire audio data and video data from other devices via a network, decode the data as appropriate, and store the data in a built-in hard disc, for example.

Further, the hard disc recorder 1200 can decode audio data and video data recorded in the built-in hard disc and supply the data to a monitor 1260, thereby displaying images of the data on a screen of the monitor 1260 and outputting sounds of the data from a speaker of the monitor 1260, for example. In addition, the hard disc recorder 1200 can also decode audio data and video data extracted from broadcast wave signals acquired via the tuner, or audio data and video data acquired from other devices via a network, and supply the data to the monitor 1260, thereby displaying images of the data on the screen of the monitor 1260 and outputting sounds of the data through the speaker of the monitor 1260.

As a matter of course, the hard disc recorder 1200 can also perform other operations.

As shown in FIG. 24, the hard disc recorder 1200 has a reception part 1221; a demodulation part 1222; a demultiplexer 1223; an audio decoder 1224; a video decoder 1225; and a recorder control part 1226. The hard disc recorder 1200 further has an EPG data memory 1227; a program memory 1228; a work memory 1229; a display converter 1230; an on screen display (OSD) control part 1231; a display control part 1232; a record reproduction 1233; a D/A converter 1234; and a communication part 1235.

In addition, the display converter 1230 also has a video encoder 1241. The record reproduction part 1233 has an encoder 1251 and a decoder 1252.

The reception part 1221 receives an infrared signal from a remote controller (not shown) and converts the signal to an electrical signal, and outputs the signal to the recorder control part 1226. The recorder control part 1226 is formed by a microprocessor or the like, for example, and performs various processes according to programs stored in the program memory 1228. The recorder control part 1226 uses the work memory 1229 as necessary.

The communication part 1235 is connected to a network to perform a process for communications with other devices via a network. For example, the communication part 1235 is controlled by the recorder control part 1226, so as to communicate with a tuner (not shown) and output a channel-selection control signal mainly to the tuner.

The demodulation part 1222 demodulates a signal supplied from the tuner and outputs the signal to the demultiplexer 1223. The demultiplexer 1223 divides the data supplied from the demodulation part 1222 into audio data, video data, and EPG data, and outputs the separated data to the audio decoder 1224, the video decoder 1225, and the recorder control part 1226, respectively.

The audio decoder 1224 decodes the input audio data and outputs the data to the record reproduction part 1233. The video decoder 1225 decodes the input video data and outputs the data to the display converter 1230. The recorder control part 1226 supplies the input EPG data to the EPG data memory 1227 for storage.

The display converter 1230 encodes the video data supplied from the video decoder 1225 or the recorder control part 1226, by the use of the video encoder 1241 to video data according to a national television standards committee (NTSC) scheme, for example, and outputs the data to the record reproduction part 1233. The display converter 1230 also converts the screen size of video data supplied from the video decoder 1225 or the recorder control part 1226 to a size corresponding to the size of the monitor 1260, and converts the video data by the use of the video encoder 1241 to video data according to the NTSC scheme, converts the data into an analog signal, and outputs the data to the display control part 1232.

The display control part 1232 superimposes an OSD signal output from the on screen display (OSD) control part 1231 on a video signal input from the display converter 1230, outputs the signal to a display of the monitor 1260 for display, under control of the recorder control part 1226.

In addition, the monitor 1260 is also supplied with audio data that is output from the audio decoder 1224 and is converted to an analog signal by the D/A converter 1234. The monitor 1260 outputs the audio signal through a built-in speaker.

The record reproduction part 1233 has a hard disc as a recording medium recording video data, audio data, and the like.

The record reproduction part 1233 encodes audio data supplied from the audio decoder 1224 by the use of the encoder 1251, for example. The record reproduction part 1233 also encodes video data supplied from the video encoder 1241 of the display converter 1230, by the use of the encoder 1251. The record reproduction part 1233 combines coded data of the audio data and coded data of the video data by the use of a multiplexer. The record reproduction part 1233 subjects the combined data to channel coding and amplification, and writes the data into the hard disc via a recording head.

The record reproduction part 1233 reproduces the data recorded in the hard disc via a reproduction head, amplifies the data, and divides the data into audio data and video data by a demultiplexer. The record reproduction part 1233 decodes the audio data and the video data by the use of the decoder 1252. The record reproduction part 1233 subjects the decoded audio data to D/A conversion and outputs the data to the speaker of the monitor 1260. The record reproduction part 1233 also subjects the decoded video data to D/A conversion, and outputs the data to the display of the monitor 1260.

The recorder control part 1226 reads latest EPG data from the EPG data memory 1227 according to a user instruction indicated by an infrared signal from a remote controller received via the reception part 1221 and supplies the data to the OSD control part 1231. The OSD control part 1231 generates image data corresponding to the input EPG data, and outputs the data to the display control part 1232. The display control part 1232 outputs the video data input from the OSD control part 1231 to the display of the monitor 1260 for display. Accordingly, an EPG (electronic program guide) is displayed on the display of the monitor 1260.

In addition, the hard disc recorder 1200 can acquire various kinds of data such as video data, audio data, and EPG data, supplied from other devices via a network such as the Internet.

The communication part 1235 is controlled by the recorder control part 1226 so as to acquire video data, audio data, and coded data such as EPG data, transmitted from other devices via a network, and supplies the data to the recorder control part 1226. The recorder control part 1226 supplies the coded data of the acquired video data and audio data to the record reproduction part 1233 for storage in the hard disc. At that time, the recorder control part 1226 and the record reproduction part 1233 may perform a re-encoding process or the like as necessary.

In addition, the recorder control part 1226 decodes the coded data of the acquired video data and audio data, and supplies obtained video data to the display converter 1230. The display converter 1230 processes the video data supplied from the recorder control part 1226, in the same manner as with the video data supplied from the video decoder 1225, and supplies the data to the monitor 1260 via the display control part 1232 for display of images.

In addition, in concert with the image display, the recorder control part 1226 may supply the decoded audio data to the monitor 1260 via the D/A converter 1234 so as to output sounds through the speaker.

Further, the recorder control part 1226 decodes the coded data of the acquired EPG data, and supplies the decoded EPG data to the EPG data memory 1227.

The hard disc recorder 1200 as described above uses the video decoder 1225, the decoder 1252, and the image decoding device 200 as a decoder built in the recorder control part 1226. That is, the video decoder 1225, the decoder 1252, and the decoder built in the recorder control part 1226, generate predicted images using curved surface parameters extracted from coded data supplied from the image coding device 100, and then generate decoded image data from residual information using the predicted images, as in the case of the image decoding device 200. Therefore, the video decoder 1225, the decoder 1252, and the decoder built in the recorder control part 1226, can further improve coding efficiency.

Therefore, the hard disc recorder 1200 can further improve efficiency of coding video data (coded data) to be received by a tuner or the communication part 1235 and video data (coded data) to be reproduced by the record reproduction part 1233, thereby realizing real-time processes at lower costs.

In addition, the hard disc recorder 1200 uses the image coding device 100 as the encoder 1251. Therefore, the encoder 1251 performs curved surface approximation using pixel values of process target blocks of original images, thereby to generate predicted images, as in the case of the image coding device 100. Therefore, the encoder 1251 can further improve coding efficiency.

Therefore, the hard disc recorder 1200 can further improve coding efficiency for coded data to be recorded in the hard disc, for example, thereby realizing real-time processes at lower costs.

In the foregoing description, the hard disc recorder 1200 records video data and audio data in a hard disc. As a matter of course, any other recording medium may be used. For example, the image coding device 100 and the image decoding device 200 can also be applied to recorders using recording media other than hard discs, such as a flash memory, an optical disc, or a video tape, in the same manner as with the hard disc recorder 1200 described above.

### 7. Seventh Embodiment

### [Camera]

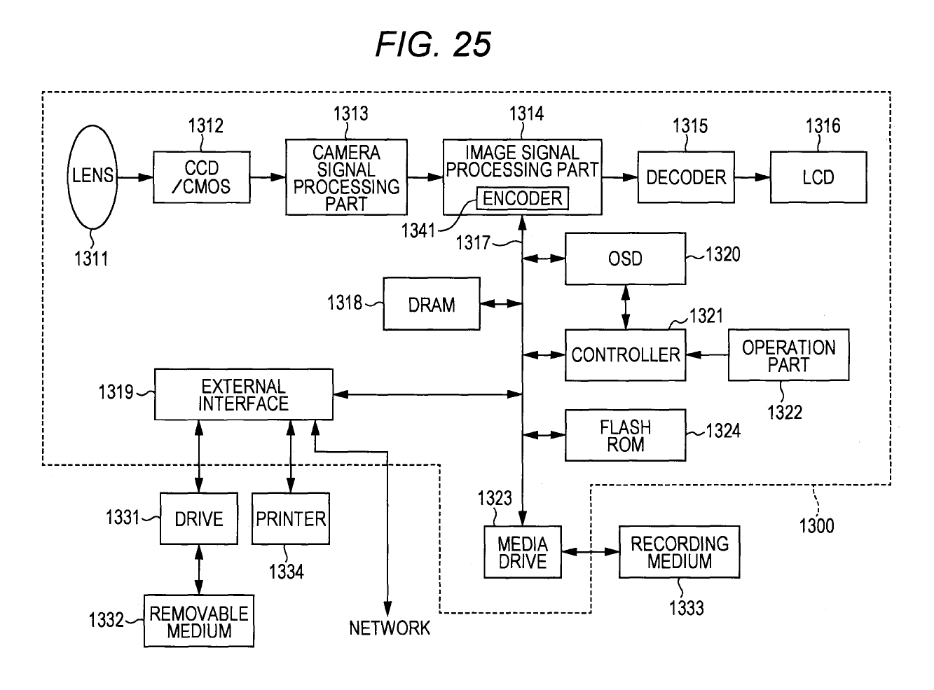

FIG. 25 is a block diagram showing a major configuration example of a camera using the image coding device 100 and the image decoding device 200 to which the invention is applied.

The camera 1300 shown in FIG. 25 shoots a subject, and displays an image of the subject on an LCD 1316 or records the image as image data in a recording medium 1333.

A lens block 1311 allows light (that is, a video image of the subject) to enter a CCD/CMOS 1312. The CCD/CMOS 1312 is an image sensor using a CCD or a CMOS, which converts strength of the received light into an electrical signal, and supplies the signal to a camera signal processing part 1313.

The camera signal processing part 1313 converts the electrical signal supplied from the CCD/CMOS 1312 into color-difference signals of Y, Cr, and Cb, and supplies the signal to an image signal processing part 1314. The image signal processing part 1314 performs a predetermined image process on the image signals supplied from the camera signal processing part 1313 or encodes the image signals by the use of an encoder 1341, under control of the controller 1321. The image signal processing part 1314 supplies coded data generated by coding the image signals, to a decoder 1315. Further, the image signal processing part 1314 acquires display data generated at an on screen display (OSD) 1320, and supplies the data to the decoder 1315.

In the foregoing process, the camera signal processing part 1313 uses as appropriate a dynamic random access memory (DRAM) 1318 connected via a bus 1317, thereby to allow the DRAM 1318 to hold image data, coded data obtained by coding the image data, and the like, as necessary.

The decoder 1315 decodes the coded data supplied from the image signal processing part 1314, and supplies obtained image data (decoded image data) to the LCD 1316. The decoder 1315 also supplies the display data supplied from the image signal processing part 1314 to the LCD 1316. The LCD 1316 combines as appropriate images of the decoded image data and images of the display data supplied from the decoder 1315, and displays combined images.

The on screen display 1320 outputs display data for menu screens, icons, and the like, formed by symbols, characters, or graphics, to the image signal processing part 1314 via the bus 1317, under control of the controller 1321.

The controller 1321 performs various processes according to a signal indicative of contents specified by a user using an operation part 1322, and controls the image signal processing part 1314, the DRAM 1318, an external interface 1319, the on screen display 1320, a media drive 1323, and the like, via the bus 1317. A flash ROM 1324 stores programs, data, and the like needed for the controller 1321 to perform various operations.

For example, the controller 1321 can encode image data stored in the DRAM 1318 or decode coded data stored in the DRAM 1318, in place of the image signal processing part 1314 or the decoder 1315. At that time, the controller 1321 may perform coding and decoding processes by the same schemes as those of the image signal processing part 1314 and the decoder 1315, or by schemes not supported by the image signal processing part 1314 and the decoder 1315.

In addition, if an instruction for stating of image printing is issued from the operation part 1322, for example, the controller 1321 reads image data from the DRAM 1318, and supplies the data for printing to a printer 1334 connected to the external interface 1319 via the bus 1317.

Further, if an instruction for image recording is issued from the operation part 1322, for example, the controller 1321 reads coded data from the DRAM 1318, and supplies the data for storage to the recording medium 1333 attached to the media drive 1323 via the bus 1317.

The recording medium 1333 is an arbitrary readable/writable removal medium such as a magnetic disc, a magnet-optical disc, an optical disc, or a semiconductor memory, for example. The recording medium 1333 may be a removable medium of any kind, and may be a tape device, a disc, or a memory card. As a matter of course, the recording medium 1333 may be a non-contact IC card or the like.

In addition, the media drive 1323 and the recording medium 1333 may be integrated so as to be formed by an irremovable recording medium such as a built-in hard disc drive or a solid state drive (SSD), for example.

The external interface 1319 is formed by a USB input/output terminal or the like, for example, and is connected to the printer 1334 for image printing. In addition, the external interface 1319 is connected to as necessary to the drive 1331, and is attached as appropriate to a removable medium 1332 such as a magnetic disc, an optical disc, or a magnet-optical disc, and computer programs read from those media are installed as necessary to the flash ROM 1324.

Further, the external interface 1319 has a network interface connected to a predetermined network such as a LAN, or the Internet. The controller 1321 reads coded data from the DRAM 1318 according to an instruction from the operation part 1322, for example, and supplies the data from the external interface 1319 to other devices connected via the network. In addition, the controller 1321 can acquire coded data or image data supplied from other devices via the network, via the external interface 1319, and allow the DRAM 1318 to hold the data or supply the data to the image signal processing part 1314.

The camera 1300 described above uses the image decoding device 200 as decoder 1315. That is, the decoder 1315 generates predicted images using curved surface parameters extracted from coded data supplied from the image coding device 100, and generates decoded image data from residual information using the predicted images, as in the case of the image decoding device 200. Therefore, the decoder 1315 can further improve coding efficiency.

Therefore, the camera 1300 can further improve coding efficiency for image data generated at the CCD/CMOS 1312, coded data of video data read from the DRAM 1318 or the recording medium 1333, and coded data of video data acquired via a network, thereby realizing real-time processes at lower costs.

In addition, the camera 1300 uses the image coding device 100 as the encoder 1341. The encoder 1341 performs curved surface approximation using pixel values of process target blocks of original images, thereby generating predicted images, as in the case of the image coding device 100. Therefore, the encoder 1341 can further improve coding efficiency.

Therefore, the camera 1300 can further improve coding efficiency for coded data stored in the DRAM 1318 and the recording medium 1333 and coded data provided to other devices, for example, thereby realizing real-time processes at lower costs.

The decoding method used by the image decoding device 200 may be applied to a decoding process performed by the controller 1321. Similarly, the coding method used by the image coding device 100 may be applied to a coding process performed by the controller 1321.

In addition, image data shot by the camera 1300 may be moving image data or still image data.

As a matter of course, the image coding device 100 and the image decoding device 200 can also be applied to devices and systems other than the devices described above.

### REFERENCE SIGNS LIST

100 Image coding device
114 Intra prediction part
132 Curved surface predicted image generation part
151 Orthogonal transform part
152 Direct-current component block generation part
153 Orthogonal transform part
154 Curved surface generation part
155 Entropy coding part
161 Curved surface block generation part
162 Inverse orthogonal transform part
200 Image decoding device
211 Intra prediction part
221 Intra prediction mode determination part
223 Entropy decoding part
224 Curved surface generation part
231 Curved surface block generation part
232 Inverse orthogonal transform part

1. An image processing device comprising:
a curved surface parameter generation means that generates a curved surface parameter indicative of a curved surface approximating a pixel value of a process target block of image data to be subjected to in-screen coding as a target, using the pixel value of the process target block;
a curved surface generation means that generates the curved surface, as a predicted image, represented by the curved surface parameter generated by the curved surface parameter generation means;
an arithmetic means that subtracts the pixel value of the curved surface generated as the predicted image by the curved surface generation means from the pixel value of the process target block, thereby to generate differential data; and
a coding means that encodes the differential data generated by the arithmetic means.

2. The image processing device according to claim 1, wherein
the curved surface parameter generation means generates the curved surface parameter by orthogonally transforming a direct-current component block formed by a direct-current component of coefficient data of the orthogonally transformed the process target block, and
the curved surface generation means generates the curved surface by subjecting the curved surface block having as a component the curved surface parameter generated by the curved surface parameter generation means, to inverse orthogonal transform.

3. The image processing device according to claim 2, wherein the curved surface generation means forms a curved surface block with the same size as an in-screen prediction block size for use in in-screen prediction, thereby to subject the curved surface block of the same block size as the in-screen prediction block size to inverse orthogonal transform.

4. The image processing device according to claim 3, wherein the curved surface size block has a curved surface parameter and 0 as components.

5. The image processing device according to claim 4, wherein
the in-screen prediction block size is 8×8, and
the direct-current component block size is 2×2.

6. The image processing device according to claim 1, further comprising:
an orthogonal transform means that subjects the differential data generated by the arithmetic means to orthogonal transform; and
a quantization means that quantizes coefficient data generated through orthogonal transforming of the differential data by the orthogonal-transform means,
wherein the coding means encodes the coefficient data quantized by the quantization means, thereby to generate coded data.

7. The image processing device according to claim 6, further comprising a transfer means that transforms the coded data generated by the coding means and the curved surface parameter generated by the curved surface parameter generation means.

8. The image processing device according to claim 7, wherein
the coding means encodes the curved surface parameter generated by the curved surface parameter generation means, and
the transfer means transfers the curved surface parameter coded by the encoding means.

9. An image processing method used by an image processing device, wherein
a curved surface parameter generation means of the image processing device generates a curved surface parameter indicative of a curved surface approximating a pixel value of a process target block of image data to be subjected to in-screen coding as a target, using the pixel value of the process target block,
a curved surface generation means of the image processing device generates the curved surface, as a predicted image, represented by the curved surface parameter generated,
an arithmetic means of the image processing device subtracts the pixel value of the curved surface generated as the predicted image from the pixel value of the process target block, thereby to generate differential data, and
a coding means of the image processing device encodes the differential data generated.

10. An image processing device, comprising:
a decoding means that decodes coded data formed by coding differential data between image data and a predicted image subjected to intra prediction using the image data;
a curved surface generation means that generates the predicted image formed by the curved surface using a curved surface parameter indicative of a curved surface approximating a pixel value of a process target block of the image data; and
an arithmetic means that adds the predicted image generated by the curved surface generation means to the differential data obtained through decoding by the decoding means.

11. The image processing device according to claim 10, wherein the curved surface generation means generates the curved surface, by subjecting to inverse orthogonal transform, a curved surface block having as a component the curved surface parameter generated by orthogonally transforming a direct-current component block formed by a direct-current component of coefficient data of the orthogonally transformed process target block.

12. The image processing device according to claim 11, wherein the curved surface generation means forms a curved surface block with the same size as an in-screen prediction block size for use in in-screen prediction, thereby to subject the curved surface block of the same block size as the in-screen prediction block size to inverse orthogonal transform.

13. The image processing device according to claim 12, wherein the curved surface size block has a curved surface parameter and 0 as components.

14. The image processing device according to claim 13, wherein
the in-screen prediction block size is 8×8, and
the direct-current component block size is 2×2.

15. The image processing device according to claim 10, further comprising:
an inverse quantization means that inversely quantizes the differential data; and
an inverse orthogonal transform means that subjects the differential data inversely quantized by the inverse quantization means, to inverse orthogonal transform,
wherein the arithmetic means adds the predicted image to the differential data subjected to inverse orthogonal transform by the inverse orthogonal transform means.

16. The image processing device according to claim 10, further comprising a reception means that receives the coded data and the curved surface parameters,
wherein the curved surface generation means generates the predicted images using the curved surface parameters received by the reception means.

17. The image processing device according to claim 10, wherein
the curved surface parameter is coded, and
the decoding means further includes a decoding means decoding the coded curved surface parameter.

18. The image processing device according to claim 10, wherein the curved surface generation means includes:
an 8×8 block generation means that generates an 8×8 block using the curved surface parameter generated; and
an inverse orthogonal transform means that subjects the 8×8 block generated by the 8×8 block generation means to inverse orthogonal transform.

19. An image processing method used by an image processing device, wherein
a decoding means of the image processing device decodes coded data formed by coding differential data between image data and a predicted image subjected to intra prediction using the image data,
a curved surface generation means of the image processing device generates the predicted image formed by the curved surface using a curved surface parameter indicative of a curved surface approximating a pixel value of a process target block of the image data, and
an arithmetic means of the image processing device adds the predicted image generated to the differential data obtained through decoding.
